(19) United States
(12) Patent Application Publication
(10) Pub. No.: US 2026/0320525 A1
(43) Pub. Date: Oct. 15, 2026

(54) SYSTEM FOR EXECUTING AUTONOMOUS AGENTS ACROSS A PLURALITY OF PROBLEM DOMAINS

(71) Applicants: UVUE LTD, Bury St Edmunds (GB); ASSMBL.AI LIMITED, Bury St Edmunds (GB)

(72) Inventors: Humayun Munir Sheikh, Bury St Edmunds (GB); Attila Bagoly, Bury St Edmunds (GB)

(21) Appl. No.: 19/558,342

(22) Filed: Mar. 5, 2026

Related U.S. Application Data
(63) Continuation-in-part of application No. 18/318,897, filed on May 17, 2023, now Pat. No. 12,620,019.
(63) Continuation-in-part of application No. 18/644,761, filed on Apr. 24, 2024.

(51) Int. Cl. G06Q 10/0631; G06F 21/60

(52) U.S. Cl. CPC G06Q 10/06316; G06F 21/602; G06Q 10/063112

(57) ABSTRACT

Disclosed is system a system for executing autonomous agents across problem domain. System comprises client agent configured to receive service request (SR); generate objective corresponding to SR to match metadata associated with previous SR with service(s) requested in current SR, extract content from match, transform extracted content into representations; and transmit objective to orchestration agent (OA); OA comprising orchestration module configured to execute artificial intelligence (AI) model using objective, retrieve tasks associated with previous queries to obtain tasks associated with objective, interactively execute AI model to obtain AA capable of performing tasks, and assign AA with task; invocation AA upon receiving signal from orchestration module; and composition module composes AA into composite agent to execute instructions defined in TS to sequentially perform each task.

### CROSS REFERENCE TO RELATED APPLICATION

This application is a continuation-in-part of U.S. patent application Ser. No. 18/318,897 filed May 17, 2023. The said application is incorporated by reference herein.

### TECHNICAL FIELD

The present disclosure relates generally to systems that execute autonomous agents across plurality of problem domains.

### BACKGROUND

Autonomous agents (AAs) have gained significant attention in recent years as a promising technology for addressing complex tasks across various problem domains. The AAs possess the ability to perceive their environment, make decisions, and take actions autonomously, thereby reducing the need for direct human intervention. However, existing systems that employ autonomous agents face several limitations and challenges that hinder their widespread adoption and effectiveness.

Traditional centralized architectures often struggle to handle large-scale deployments of the autonomous agents. As the number of autonomous agents and the complexity of tasks increase, the centralized control and communication become bottlenecks, leading to performance degradation and inefficiencies. Moreover, coordinating the actions of numerous autonomous agents operating in a decentralized (i.e. distributed) manner becomes increasingly difficult, impeding the system's ability to effectively solve complex problems.

Existing systems often lack robust mechanisms for agents to collaborate and exchange information seamlessly. This hinders their ability to work together on interconnected tasks or to transfer knowledge between the autonomous agents, limiting their overall problem-solving capabilities. Additionally, the lack of standardized protocols and frameworks for agent coordination poses interoperability challenges and inhibits the development of versatile and flexible multi-agent systems.

The existing systems often lack robust mechanisms for handling security and safety concerns. Moreover, the autonomous agents of the existing systems fail to understand a service request completely, thereby leading to a failure in fulfilling the service request obtained from a user. Furthermore, the existing autonomous agents misinterpret queries or fail to recognize context. The existing autonomous agents often struggle with understanding and maintaining context during extended conversations or interactions. The existing autonomous agents may fail to remember previous queries, responses, or user preferences, resulting in disjointed and less effective interactions. The existing autonomous agents struggle with tasks that involve multi-step processes, require creative thinking, or demand comprehensive domain knowledge.

Furthermore, the existing systems lack structured mechanisms for decomposing a high-level service request into executable task specifications and for programmatically assigning such tasks to appropriate autonomous agents across heterogeneous environments. In particular, conventional approaches do not provide reliable methods for dynamically discovering capable agents, generating formalized execution mappings between tasks and agents, or composing multiple agents into a controlled execution unit. The absence of deterministic task-to-agent allocation and execution sequencing mechanisms results in inconsistent task execution, inefficient resource utilization, and unreliable fulfilment of complex service requests spanning multiple problem domains.

Therefore, in light of the foregoing technical problems, there exists a need to overcome the aforementioned problems associated with existing AAs.

### SUMMARY

The present disclosure seeks to provide a system for executing autonomous agents across a plurality of problem domains. The present disclosure also seeks to provide a system that enables application of autonomous agents across a plurality of problem domains. The present disclosure further seeks to provide a method for enabling application of AAs across plurality of problem domains. An aim of the present disclosure is to provide a solution that overcomes at least partially the problems encountered in prior art.

### DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, the present disclosure provides a system (600) for executing autonomous agents across a plurality of problem domains, the system comprising a client agent (602) configured to:
receive a service request;
generate an objective corresponding to the service request by executing at least one data processing algorithm to match metadata associated with previous service requests with at least one service requested in the current service request, extract content from the match, and transform the extracted content into one or more structured data representations stored in a database, wherein the objective is in the form of the one or more structured data representations stored in the database; and
transmit the objective to an orchestration agent communicably coupled to the client agent;
the orchestration agent (604) comprising:
an orchestration module (606) configured to:
execute one or more algorithms of an artificial intelligence (AI) model (608) using the objective as an input parameter;
retrieve one or more tasks associated with previous queries to obtain a plurality of tasks associated with the objective;
(optionally interactively) execute the one or more algorithms of the AI model to obtain a list of a plurality of autonomous agents that are capable of performing the plurality of tasks and are associated with the objective; and
assign at least one autonomous agent from the plurality of autonomous agents to at least one task such that each task is assigned to at least one autonomous agent;
an invocation generator module (610) configured to, upon receiving a signal from the orchestration module, generate at least one task specification for execution of each task by the at least one autonomous agent associated with the task, using a structured invocation format; and
a composition module (612) configured to compose each autonomous agent corresponding to the objective into a composite agent (614) by generating a configuration data structure comprising execution logic defining associations between the plurality of autonomous agents and the plurality of task specifications assigned to the objective, thereby establishing a unified execution context for the composite agent,
wherein the composite agent is configured to execute the at least one task specification in accordance with the execution logic defined in the configuration data structure.

The transformed objective may be stored as structured data representations in a database, wherein the database may recorded in any data storage medium.

Optionally, the orchestration module is further configured to interactively communicate with the AI model to obtain an order in which each task is to be executed, wherein the order is dynamically determined based on at least one of availability, cost, or user preferences.

Optionally, the orchestration module is further configured to block communication signals between the client agent and autonomous agents that are not associated with the objective.

Optionally, the orchestration module is further configured to obtain the list of the plurality of autonomous agents using a registry component comprising a database of autonomous agents and their components, and a search and discovery component configured to determine, using the database, autonomous agents capable of performing the at least one task.

Optionally, each autonomous agent stored in the registry component is associated with metadata comprising at least one of: capabilities of the autonomous agent, a pricing parameter, or an availability status, wherein the orchestration module is further configured to select at least one autonomous agent from the plurality of autonomous agents based on the metadata associated with each autonomous agent in the registry component.

Optionally, upon completion of a task by the composite agent, the composition module is further configured to generate a task completion record stored in the data store, the task completion record comprising an identifier of the completed task and an identifier of the at least one autonomous agent that performed the task, and wherein the task completion record triggers a cryptographically secured transaction between the client agent and the at least one autonomous agent based on the pricing parameter associated with the autonomous agent.

In some embodiments, the composition module generates a configuration data structure that encodes execution logic defining associations between task specifications and corresponding autonomous agents. The configuration data structure may comprise machine-readable mapping entries that define routing rules executable by the composite agent to determine which autonomous agent performs each task specification. The composite agent executes task specifications in accordance with the execution logic encoded in the configuration data structure, such that task routing and agent invocation are governed by the encoded routing rules. The configuration data structure establishes a unified execution context in which the associated autonomous agents operate under the defined execution logic. the task specification is generated using a structured invocation format comprising defined parameter fields and operation identifiers.

Optionally, the cryptographically secured transaction is recorded as an immutable entry in the data store, the immutable entry being cryptographically linked to the task completion record such that the transaction cannot be altered after being recorded.

Optionally, the registry component is further configured to track task completion records associated with each autonomous agent stored in the database, and compute a reputation score for each autonomous agent based on at least one of: a number of successfully completed tasks, a task completion latency, or a task success indicator, each derived from the task completion records stored in the data store.

Optionally, the reputation score for each autonomous agent is stored as a representation in the data store, and wherein the orchestration module is further configured to retrieve the reputation score for each autonomous agent from the data store and apply the reputation score as a weighted selection parameter when selecting autonomous agents from the plurality of autonomous agents for association with the at least one task.

Optionally, the orchestration module is further configured to transmit, to one or more autonomous agents capable of performing at least one task associated with the objective, a query requesting terms for performing the at least one task, receive from each of the one or more autonomous agents a respective offer comprising execution terms including at least one of a pricing parameter, an estimated completion time, or capability metadata, and select at least one autonomous agent based on a comparison of the execution terms received from the one or more autonomous agents.

Optionally, generating the objective further comprises referring the service request to a large language model configured to transform the service request into service data in the form of one or more representations stored in the data store, and using the service data as the objective.

Optionally, the orchestration module is further configured to transmit a list of the plurality of tasks associated with the objective to a device of a user, and to receive from the device an input indicative of at least one of: which tasks are to be executed, or an order in which the tasks are to be executed.

Optionally, the orchestration module is further configured to selectively enable communication between the client agent and autonomous agents that are associated with the objective while simultaneously blocking communication between the client agent and autonomous agents that are not associated with the objective, such that only autonomous agents associated with the objective participate in execution of the service request.

Optionally, the composition module is further configured to apply access controls to the composite agent such that only autonomous agents associated with the objective are authorized to interact with the composite agent during execution of each task associated with the objective.

Optionally, the access controls applied to the composite agent are enforced using cryptographic keys, wherein each autonomous agent associated with the objective is issued a respective cryptographic key authorizing interaction with the composite agent, and wherein autonomous agents not associated with the objective are denied access by absence of a valid cryptographic key.

Optionally, the composition module is further configured to restrict access of the composite agent to only resources authorized for execution of the tasks associated with the objective, wherein resources not authorized for the objective are inaccessible to the composite agent during execution of the service request.

Optionally, the authorized resources comprise at least one of: data accessible to the composite agent, communication channels available to the composite agent, or autonomous agents permitted to interact with the composite agent during execution of the tasks associated with the objective.

Optionally, the composition module is further configured to generate an audit log recording actions taken by the composite agent during execution of each task associated with the objective, wherein the audit log comprises at least one of: an identifier of each task executed, an identifier of each autonomous agent that performed the task, or a timestamp associated with execution of each task.

Optionally, the audit log is stored as an immutable record in the data store, cryptographically linked to the composite agent such that the audit log cannot be altered after recordation.

Optionally, the composite agent is cryptographically linked to each autonomous agent associated with the objective such that the functioning of the composite agent cannot be altered after composition, and wherein any attempt to modify the composite agent after composition is detectable by the orchestration module.

Optionally, the order in which each task is to be executed is validated by the AI model prior to execution, and wherein upon validation, each task is appended to an execution chain such that tasks are executed sequentially in the validated order and the execution chain is immutable after validation of each task.

Optionally, the components of the autonomous agents comprise at least one of: skills, protocols, connections, of the autonomous agents.

In another aspect, the present disclosure further provides a method for enabling application of AAs across a plurality of problem domains, the method comprising:
receiving a service request at a client agent;
generating an objective corresponding to the service request by executing at least one data processing algorithm to match metadata associated with previous service requests with at least one service requested in the current service request, extracting content from the match, and transforming the extracted content into one or more structured data representations stored in a database, wherein the objective is in the form of the one or more structured data representations stored in the database;
transmitting the objective to an orchestration agent communicably coupled to the client agent;
executing, by the orchestration agent, one or more algorithms of an artificial intelligence (AI) model using the objective as an input parameter;
retrieving one or more tasks associated with previous queries to obtain a plurality of tasks associated with the objective;
obtaining a list of a plurality of autonomous agents capable of performing the plurality of tasks; assigning at least one autonomous agent to at least one task;
generating at least one task specification for execution of each task by the at least one autonomous agent using a structured invocation format; generating a configuration data structure comprising execution logic defining associations between the plurality of autonomous agents and the plurality of task specifications assigned to the objective, thereby establishing a unified execution context; and
executing the at least one task specification in accordance with the execution logic defined in the configuration data structure.

The computer implemented method of the present invention comprises all steps the system is configured to execute, as described below and in the appended claims.

Embodiments of the present disclosure substantially eliminate or at least partially address the aforementioned problems in the prior art, and enable application of AAs across a plurality of problem domains. Optionally, the system uses the software framework utilizes the full potential of AI models such as Generative Pre-trained Transformer (GPT) such as a ChatGPT (ChatGPT is a registered trademark) by integrating the large Language models with the external data sources and making the large Language models more powerful by providing context to the service request and memory for storing the previous interactions. The software framework enables the development of applications or fulfilling the service request by organizing a series of tasks and using large language models to identify the next task. The software framework enables the development of new agents corresponding to the tasks identified or composing multiple existing agent devices (AA or micro-AAs) that in combination can fulfil the objective of the service request. For example, whenever the service request comes, the software framework enables the fulfilment of service request by generating context (objective) and using LLM to generate a series of intermediate tasks and chaining this sequence together to fulfil the request. Additionally, the system enables the efficient application of AAs across different problem domains by providing a flexible and scalable framework for coordination, task execution, and secure communication among the AAs. As a result, enhance stability and performance in the operation of the system are achieved. Furthermore, the machine learning model agent (ML-Model AA) provides an order in which each task is to be executed. Furthermore, the system provides computational benefits and also enables the plurality of AAs to set-up secure, encrypted channels with each other.

Additional aspects, advantages, features, and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system that enables application of AAs across a plurality of problem domains, in accordance with an embodiment of the present disclosure;

FIG. 2 is an illustration of an architecture of a decentralized (i.e. distributed) computing network of the system of FIG. 1, in accordance with an embodiment of the present disclosure;

FIG. 3 is an illustration of technical building blocks of the system of FIG. 1, in accordance with an embodiment of the present disclosure;

FIG. 4 is a schematic illustration of journey of a user when the user uses the system of FIG. 1, in accordance with an embodiment of the present disclosure;

FIGS. 5A and 5B illustrate a flowchart illustrating steps of a method for enabling application of AAs across a plurality of problem domains, in accordance with an embodiment of the present disclosure; and

FIG. 6 is a block diagram of a system for executing autonomous agents across a plurality of problem domains, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

It will be appreciated that, in the context of the present disclosure, the term “agent” refers to a software-implemented autonomous execution entity configured to perform one or more tasks and interact with other agents within the system, and which may operate using at least one processor and associated memory. In contrast, the term “module” refers to a processor-executable functional component within an agent that performs a defined internal operation in support of the agent's behavior, wherein a module is not independently operable as a system-level autonomous entity. Accordingly, an agent may comprise one or more modules, and a module may instantiate, configure, or coordinate one or more agents without itself constituting an agent.

Throughout the present disclosure the term “autonomous agents” (referred to herein later as “AAs”) as used herein, relates to computational entities or software programs that are designed to perform tasks or make decisions autonomously, without direct human intervention. The AAs have the ability to perceive their environment, analyze information, and take actions based on predefined rules, algorithms, or learning capabilities. Optionally, the autonomous agent is an autonomous economic agent (AEA). In this regard, an autonomous micro-agent is optionally a micro autonomous economic agent (micro-AEA). Optionally, the autonomous economic agent (AEA) relates to a software module, or any device comprising at least one software module that is configured to execute one or more tasks. Such tasks may include communication of the autonomous economic agents (AEAs) with each other, processing of information, and so forth. In an example, the autonomous economic agents (AEAs) are configured to employ artificial intelligence (AI) algorithms and machine learning for the execution of the one or more tasks. Notably, all autonomous economic agents (AEAs) are autonomous agents (AAs) but not all AAs are autonomous agents (AAs).

Throughout the present disclosure, the term “client agent” refers to a software-implemented autonomous agent configured to receive a service request (defined later) and generate an objective corresponding to the service request for downstream orchestration and execution. The client agent may be implemented in various forms, including as a client-agent device (client-AA) comprising a computing device executing a software application, or as a software module executing within a distributed computing environment, cloud infrastructure, or other computing platform. Accordingly, the client-agent device represents one implementation of the client agent, and it will be appreciated that throughout the present disclosure the client agent may be referred to as the client-agent device (client-AA). It will be appreciated that the client agent broadly encompasses the functional software entity responsible for initiating objective (defined later) generation within the system. Herein, the client-agent device (client-AA) is communicably coupled with the agent-device (AA or micro-AA) that enables operation of the client-agent device (client-AA) within complex environments. It will be appreciated that the agent-device (AA or micro-AA) possesses an ability to incorporate external resources and collaborate with other agent-devices (AA or micro-AAs) to perform tasks that would be difficult for the client-agent device (client-AA) to accomplish alone. Optionally, agent-device (AA or micro-AA) promotes secure co-learning of the client-agent device (client-AA).

In an example, the client-agent device (client-AA) includes a portable communication device. For example, the client-agent device (client-AA) is at least one of a smartphone, a laptop computer or a tablet computer or a software module in the user device. Optionally, the client-agent device (client-AA) could be an interface between the agent-device (AA or micro-AA) and an agent marketplace, enabling autonomous participation and decision-making within the ecosystem. Herein, the agent-device (AA or micro-AA) refers to a computing device or software module that operates as an autonomous agent within the system.

The system comprises a plurality of modular and extensible software modules configured to operate as the AAs meaning that the AAs are modular and extensible, thus the AAs are self-sufficient entities communicably coupled with the system that could function independently and could be adapted or modified as needed to fit various use cases/circumstances based on their own rules and objectives. The AAs are modular, meaning that they are composed of separate parts or units that can be combined together in various manners to achieve a variety of functionalities. The AAs are extensible, meaning that their existing functionalities are capable of being extended further by addition of newer modular parts or units.

As used herein, “modular” refers to an architectural structure in which functional components are implemented as discrete, self-contained software units having defined interfaces that permit independent deployment, modification, replacement, or reuse without requiring modification of other components of the system. “Extensible” refers to the capability of the system to incorporate additional functional components, capabilities, or interfaces through the addition of new modules or the augmentation of existing modules via defined interface contracts, without requiring redesign of the underlying system architecture.

As used herein, a “configuration data structure” refers to a machine-readable structured data construct generated during composition of the composite agent, the data construct comprising execution logic that defines associations between task specifications and corresponding autonomous agents. The configuration data structure may include mapping entries, routing rules, parameter bindings, and execution constraints that are interpretable by the composite agent to govern invocation and task routing.

As used herein, a “unified execution context” refers to a coordinated runtime environment established for the composite agent in which execution of multiple task specifications is governed by the execution logic encoded in the configuration data structure, such that associated autonomous agents operate under common routing, invocation, and resource-control parameters defined during composition.

It will be appreciated that when multiple AAs work collectively for an application (i.e., use case), different steps of the application are completed by different AAs. The multiple AAs work in consensus to collectively reach a final outcome for achieving a required functionality of said application. Additionally, the AAs could be modulated to perform new tasks, respond to changing market conditions, or interact with new environment without disrupting the overall functioning thereof or the system it operates within. This ability to expand and adapt makes AAs more versatile and sustainable, thereby making the AAs future proof. Herein, the plurality of problem domains may include, but is not limited to, energy, finance, supply chain, governance, manufacturing, mobility, smart cities, and internet of things (IoT) applications.

Upon receiving the service request, the client agent is configured to generate the objective associated with the service request. The client agent processes the service request (for example, using at least one processor configured to execute various instruction sets to achieve the required objective), to derive structured metadata and leveraging historical metadata corresponding to previously processed service requests stored in a data store. The term “metadata” as used herein refers to structured descriptive information characterizing attributes of a service request, including but not limited to: a service type (e.g., travel booking, procurement, scheduling), a problem domain identifier, entities involved (e.g., vendor identifiers, destination identifiers), temporal constraints, geographic parameters, cost constraints, user preferences, device/account identifiers, and optionally historical execution outcomes and performance indicators. Such metadata may be extracted from the service request using parsing routines, natural language processing modules, or predefined schema mappings, and may be normalized into structured fields suitable for computational comparison. Such metadata may be extracted from the service request using parsing routines, natural language processing modules, or predefined schema mappings, and may be normalized into structured fields suitable for computational comparison. In this regard, the client agent employs at least one data processing algorithm to match metadata associated with previous service requests with at least one service requested in the current service request.

The term “data processing algorithm” as used herein refers to a processor-executable computational procedure configured to perform comparison, classification, ranking, similarity determination, clustering, or retrieval operations over structured data. Examples of such algorithms include, but are not limited to, rule-based matching algorithms, keyword or token comparison routine algorithms, weighted scoring functions over metadata attributes, vector similarity computations including cosine similarity or Euclidean distance over embedded representations, clustering algorithms, and machine learning-based classifiers. The matching operation enables the client agent to produce a ranked set of prior service requests having metadata satisfying predetermined similarity thresholds relative to the current service request. Upon identifying or determining at least one prior service request that satisfies the matching criteria, the client agent extracts relevant content from the matched prior service request, such content including, by way of example, previously validated parameter values, specific configuration data, task decomposition templates, historical execution sequences, previously selected autonomous agents, or successful execution outcomes. The extracted content is then transformed into one or more structured representations stored in the data store, such as vector embeddings, feature vectors, structured data objects, or encoded task specifications.

In such embodiments, the objective is defined in the form of the one or more representations stored in the data store, thereby providing a machine-processable, context-enriched formulation of the service request suitable for downstream orchestration, task generation, and assignment to autonomous agents. The term “one or more representations” refers to machine-processable data structures that encode a service request, objective, task definition, or extracted historical content in a structured form suitable for storage and computational use. The one or more representations may include structured data objects (e.g., JavaScript Object Notation (JSON) objects), numerical vectors (e.g., embedding vectors for similarity search), or combinations thereof, stored in a data store, optionally a vector database, such that the objective is defined in a format usable by orchestration and task execution components.

It will be appreciated that by matching metadata associated with previous service requests to the current service request, the system reduces ambiguity in interpreting the current request, improves determinism in task decomposition, enables reuse of validated execution patterns, and enhances computational efficiency by avoiding redundant re-computation of planning logic. Consequently, the generated objective reflects both the present service request and historically derived contextual information, thereby improving reliability and scalability of autonomous agent execution across multiple problem domains.

Optionally, the one or more representations comprise structured data objects, such as JSON objects, stored in the data store, optionally in a vector database. A task definition may be represented as a JSON object including an identifier, a description, and an argument schema, and selected fields of the task definition may be used to generate a numerical embedding stored alongside the task identifier and definition to enable similarity-based retrieval. Upon receiving a current service request, the client agent may generate an embedded representation of the service request or derived metadata and perform a similarity search against stored embeddings to retrieve relevant task definitions and related historical content exceeding a similarity threshold, where the retrieved information is transformed into the objective representations stored in the data store. In some embodiments, the objective comprises structured representations encoding at least one of a service type, constraints, user preferences, or references to retrieved task definitions. By matching metadata associated with previous service requests with at least one service requested in the current service request, the system improves consistency in task determination, enables reuse of previously stored task definitions, and enhances computational efficiency, such that the objective comprises machine-processable representations usable by an orchestration component (namely an orchestration agent and/or a orchestration module thereof) for task generation and execution coordination across autonomous agents.

The system comprises an orchestration agent communicably coupled to the client agent. As used herein, the term “orchestration agent” refers to a software-implemented autonomous agent configured to receive an objective from a client agent and coordinate execution of the objective by determining a plurality of tasks, selecting and/or assigning one or more autonomous agents to perform the tasks, and controlling an order and/or conditions under which the tasks are executed, wherein the orchestration agent includes at least one processor and memory storing executable instructions for performing such coordination. It will be appreciated that after the client agent generates the objective in a machine-processable form (for example, as one or more representations stored in a data store), the client agent transmits the objective to the orchestration agent that is communicably coupled to the client agent via a communication interface and one or more communication links, such as an application programming interface (API) call, an inter-process message, or a network message, optionally by transmitting an objective identifier and/or the one or more objective representations. This transmission enables a deterministic handoff from objective formation to orchestration, supports centralized and/or distributed deployment of the orchestration agent, and initiates downstream task determination, agent selection, and execution coordination to fulfil the service request.

The orchestration agent comprises an orchestration module and is communicably coupled to an invocation generator module. The term “orchestration module” refers to a processor-executable software component of the orchestration agent configured to process a received objective, determine one or more tasks derived from the objective, and assign or coordinate autonomous agents for execution of the determined tasks. The term “invocation generator module” refers to a processor-executable software component configured to generate, based on the determined tasks, structured task specifications or invocation instructions in a predefined format that enable the assigned autonomous agents to execute the tasks.

The orchestration module executes one or more algorithms of an artificial intelligence (AI) model using the objective as an input parameter, wherein the AI model may comprise a machine learning model or large language model executed by at least one processor to analyze the objective and generate inferred task information. Notably, the execution of the AI model includes providing the objective, or a representation thereof, as structured input to the AI model and receiving, as output, one or more task inferences, refinements, or ordering recommendations. This is performed to decompose a high-level objective into machine-actionable tasks suitable for automated execution. The orchestration module further retrieves one or more tasks associated with or corresponding to previous queries from a data store, such as a vector database, to obtain a plurality of tasks associated with the objective. Optionally, such step of retrieval includes performing a similarity search between an embedded representation of the objective and stored task embeddings, optionally using a similarity threshold or ranking function. This enables reuse of previously defined task templates and improves consistency and computational efficiency by avoiding redundant task generation. It will be appreciated that the orchestration module interactively executes the AI model to obtain a list of a plurality of autonomous agents capable of performing the plurality of tasks. Interactive execution may include iterative input-output exchanges between the orchestration module and the AI model, wherein task descriptions, agent capability metadata, or registry data are provided as input and the AI model outputs a ranked or filtered list of candidate autonomous agents. This process enables dynamic selection of agents based on capability, availability, constraints, or contextual relevance to the objective.

Optionally, the orchestration module is further configured to interactively communicate with the AI model to obtain an order in which each task is to be executed, wherein the order is dynamically determined based on at least one of availability, cost, or user preferences. In this regard, the orchestration module is further configured to determine an execution order for the plurality of tasks derived from the objective by interactively communicating with the artificial intelligence (AI) model. In this context, interactive communication comprises iterative input-output exchanges between the orchestration module and the AI model, wherein the orchestration module provides structured task data, task dependencies, agent capability metadata, availability information, cost parameters, and/or user preference data as input to the AI model, and receives, as output, a proposed execution sequence or priority ranking of the tasks. The AI model may evaluate constraints including agent availability (e.g., current workload or resource access), execution cost (e.g., computational cost, pricing parameters, or transaction fees), and user-defined preferences (e.g., speed, budget constraints, or service quality), and generate an optimized or context-sensitive ordering of tasks. The orchestration module may optionally validate the returned order against dependency constraints or system policies prior to execution. This dynamic determination of task order is performed to improve efficiency, reduce execution latency or cost, satisfy user-defined constraints, and ensure coherent multi-step execution of the objective across heterogeneous autonomous agents. The technical advantage is dynamically optimized task sequencing that reduces execution latency and cost while improving reliable fulfilment of the objective under availability and user-preference constraints.

It will be appreciated that the order in which each task is to be executed is validated by the AI model prior to execution, wherein validation comprises providing the proposed task sequence, task dependencies, and execution constraints to the AI model and receiving a confirmation or corrected ordering that satisfies dependency, availability, and policy constraints. Upon validation, each task is appended to an execution chain, wherein the execution chain is a structured sequence of task entries stored in memory or in a data store and representing the authorized execution order. As each task is validated, it is appended to the execution chain in the validated position, and the execution chain is rendered immutable, for example by applying append-only semantics and/or cryptographic hashing of prior entries to prevent reordering or modification after validation. Tasks are then executed sequentially according to the validated execution chain. The technical advantage is deterministic, tamper-resistant task sequencing that ensures consistent and policy-compliant multi-step execution.

Thereafter (i.e., after execution of the AI model to obtain the list of the plurality of autonomous agents), the orchestration module assigns at least one autonomous agent from the plurality of autonomous agents to at least one task, such that each task is assigned to at least one autonomous agent. The term “assign” (or “assigning”) refers to generating, using at least one processor, a task-to-agent mapping stored in memory or in a data repository, wherein the mapping records, for each task identifier, the identifier of the autonomous agent selected to execute that task. Assigning further comprises writing the task identifier and autonomous agent identifier into the mapping stored in memory or in the data repository, updating a state value of the task identifier to indicate it is assigned and generating a structured invocation instruction for the autonomous agent to execute the task. Assignment may additionally include selecting the autonomous agent based on performance metrics, cost parameters, or AI-generated recommendations, and storing this selection in the mapping. The stored mapping is used by the processor to control subsequent execution of the task by the selected autonomous agent, thereby enabling deterministic task execution, controlled coordination among agents, and consistent execution of the task across a plurality of problem domains.

The invocation generator module receives, from the orchestration module, a signal indicating that one or more tasks have been determined and that at least one autonomous agent has been assigned to each task; such signal may comprise a message, function call, event, or other inter-process notification including task identifiers and task-to-agent assignment data. Upon receipt of the signal, the invocation generator module generates at least one task specification for execution of each task by the at least one autonomous agent assigned to the task, wherein the task specification defines executable parameters including, for example, an operation identifier, required inputs, constraints, expected outputs, sequencing requirements, and/or references to authorized resources. The term “authorized resources” refers to a set of system resources that are expressly permitted for use by the composite agent for executing tasks associated with a given objective, including at least one of: data accessible to the composite agent (e.g., specific files, databases, records, or datasets), communication channels available to the composite agent (e.g., approved APIs, network endpoints, message queues, or inter-process channels), and/or autonomous agents permitted to interact with the composite agent (e.g., task-assigned agents identified by an objective-scoped allowlist and/or cryptographic credentials).

In this context, the composition module determines the authorized resources based on the task specifications and objective constraints and enforces access by configuring objective-scoped access controls, such as scoped credentials for permitted datasets, policy rules limiting outbound and inbound communications to approved channels and allow lists and/or cryptographic keys limiting inter-agent interactions to permitted autonomous agents. Resources not included in the authorized resources are rendered inaccessible to the composite agent during execution, for example by blocking requests, denying credential validation, or preventing routing to non-approved endpoints. This arrangement is performed to confine task execution to approved data and interfaces and to prevent unauthorized access or interference while fulfilling the service request.

In some embodiments, the task specification is generated using a structured invocation format, such as a schema-defined data object (e.g., JSON) having predetermined fields for the task identifier, argument names and types, validation rules, and execution context. This generation is performed to standardize and constrain agent execution, enable interoperability among heterogeneous autonomous agents, reduce ambiguity in task execution instructions, and provide a deterministic interface by which assigned autonomous agents can execute the tasks to fulfil the objective.

Optionally, the orchestration module is further configured to block communication signals between the client agent and autonomous agents that are not associated with the objective. In this context, blocking communication signals comprises programmatically restricting message routing, API calls, network transmissions, or inter-process communications such that only autonomous agents assigned to tasks corresponding to the objective are permitted to exchange data with the client agent. The orchestration module may implement such restriction by updating access control lists, filtering message queues, enforcing authorization tokens or cryptographic keys, or applying policy-based routing rules within the communication layer. This blocking is performed to prevent unauthorized or irrelevant agents from participating in execution, to reduce unnecessary resource consumption, and to enhance execution integrity and security during fulfilment of the service request. The technical advantage is improved execution integrity and resource efficiency by ensuring that only task-assigned autonomous agents participate in service fulfilment while preventing unauthorized or irrelevant inter-agent interactions.

Optionally, the orchestration module is further configured to selectively enable communication between the client agent and autonomous agents associated with the objective while blocking communication with autonomous agents not associated with the objective, such that only objective-associated agents participate in execution of the service request. Such selective control may be implemented by enforcing an objective-scoped authorization policy (e.g., allowlists, tokens/keys, or message filtering) based on a task-to-agent mapping maintained by the orchestration module. The technical advantage is improved execution integrity and security by restricting participation to authorized task-assigned autonomous agents.

Optionally, the orchestration module is further configured to obtain the list of the plurality of autonomous agents using a registry component and a search and discovery component. The term “registry component” refers to a software-implemented component comprising a database that stores records for autonomous agents, including agent identifiers and capability-related metadata (e.g., supported tasks, protocols, availability, and optional performance or pricing attributes). The term “search and discovery component” refers to a processor-executable component configured to query the registry component and determine, retrieve, or select autonomous agents capable of performing one or more tasks based on matching task requirements to the stored agent metadata. This mechanism (to obtain the list of the plurality of autonomous agents using the registry component and the search and discovery component) enables systematic discovery of suitable agents, ensures that only agents having required capabilities are considered for task execution, and supports scalable coordination across heterogeneous autonomous agents operating in a plurality of problem domains. The technical advantage is efficient and scalable agent selection by enabling structured, metadata-driven discovery of capable autonomous agents while reducing mismatched task assignments.

Optionally, the search and discovery component is further configured to perform capability matching using embedding-based similarity. The search and discovery component generates an embedding representing the at least one task associated with the objective by processing a structured task description using an embedding model. Each autonomous agent stored in the registry component may have one or more capability embeddings representing functional capabilities of the autonomous agent. The search and discovery component compares the task embedding to the capability embeddings using a similarity metric (e.g., cosine similarity) and identifies autonomous agents whose capability embeddings exceed a similarity threshold relative to the task embedding. This embedding-based matching enables semantic capability comparison beyond exact keyword matching and improves agent-task alignment across heterogeneous domains. This leads to technical advantage of improved semantic accuracy in agent selection through vector-based capability matching.

The orchestration agent also comprises a composition module which is a processor-executable software component configured to form an executable coordination unit from multiple autonomous agents selected for a given objective. The composition module composes each autonomous agent corresponding to the objective into a composite agent by combining capabilities and functionalities of the respective autonomous agents, for example by establishing a shared execution context, defining inter-agent communication interfaces, and binding agent-specific tools, skills, or protocols under a unified control structure addressable as the composite agent. The composite agent is a software-implemented execution entity formed by logically combining two or more autonomous agents selected for a given objective under a unified execution context.

In this regard, the step of composing includes generating a composite configuration that references the constituent autonomous agents, their permissions, and the subset of tasks assigned for execution, and optionally instantiating a runtime wrapper or controller that routes task invocations to the appropriate constituent agent. This composition is performed to coordinate multi-agent execution as a single controlled entity, reduce fragmentation in task handling, and enforce consistent execution flow across tasks that may span different problem domains.

Moreover, the composite agent is configured to execute, using at least one processor, executable instructions defined in the at least one task specification to sequentially perform each task assigned to the composite agent. Such execution may include parsing the structured task specifications, validating required inputs, invoking the corresponding constituent autonomous agent(s) in the specified order, and persisting intermediate outputs for use by subsequent tasks. In this regard, “performing” a task refers to the processor reading the task specification from the memory or the data repository, identifying the autonomous agent assigned to the task from the stored task-to-agent mapping, executing the instructions defined in the task specification, invoking the assigned autonomous agents and storing the outputs in the memory or the data repository. The composite agent then generates a service execution result corresponding to fulfilment of the service request, for example by aggregating task outputs into a final response, a transaction, a completed workflow state, or other machine-actionable output. In this regard, the service execution result comprises structured data generated by the processor through execution of the instructions of each assigned task, invoking the corresponding autonomous agents and storing the outputs in the memory or the data repository. This execution arrangement is needed to provide deterministic task sequencing, ensure interoperability among heterogeneous agents, and reliably fulfil the service request through coordinated performance of multiple tasks.

Optionally, each autonomous agent stored in the registry component is associated with metadata comprising at least one of: capabilities of the autonomous agent, a pricing parameter, or an availability status, wherein the orchestration module is further configured to select at least one autonomous agent from the plurality of autonomous agents based on the metadata associated with each autonomous agent in the registry component. Herein, the term “capabilities of the autonomous agent” refers to structured metadata describing the functional abilities of the autonomous agent to perform one or more tasks, including supported task types, domain expertise, executable tools, accessible resources, supported communication protocols, and/or compatible task schemas. The term “pricing parameter” refers to a structured value associated with an autonomous agent representing a cost metric for task execution, including, for example, a fixed fee, variable rate, computational cost, transaction fee, or other quantifiable economic or resource-based measure used in agent selection. The term “availability status” refers to metadata indicating the current operational state or capacity of the autonomous agent to accept and execute a task, including, for example, idle/busy state, processing load, scheduling window, resource access state, or other indicators of execution readiness. Such metadata is stored as structured fields in the registry database and may be updated over time. The orchestration module retrieves the metadata for candidate autonomous agents and selects at least one autonomous agent based on the metadata, for example by filtering for required capabilities, excluding unavailable agents, and/or ranking agents based on pricing parameters to satisfy objective constraints. The technical advantage is cost-and availability-aware selection of capable agents, improving execution efficiency and reliability.

Optionally, upon completion of a task by the composite agent, the composition module is further configured to generate a task completion record stored in the data store, the task completion record comprising an identifier of the completed task and an identifier of the at least one autonomous agent that performed the task, and wherein the task completion record triggers a cryptographically secured transaction between the client agent and the at least one autonomous agent based on the pricing parameter associated with the autonomous agent. In this context, the task completion record is a machine-readable entry that memorializes execution of a task and includes at least an identifier of the completed task and an identifier of the at least one autonomous agent that performed the task. The composition module may generate the record by receiving a completion signal and output data from the composite agent, extracting the relevant identifiers from the task specification and task-to-agent mapping, and writing the record to the data store (optionally with a timestamp and execution status). The task completion record is then used to trigger a cryptographically secured transaction between the client agent and the at least one autonomous agent, wherein the transaction amount is determined based on the pricing parameter associated with the autonomous agent (e.g., a fee or rate stored in the registry). Such triggering may include invoking a secure payment or settlement routine that signs and transmits a transaction request using cryptographic credentials (for example, digital signatures and/or encrypted communication) to effect transfer of value or authorization of payment. This mechanism is performed to provide verifiable attribution of task performance, enable automated settlement tied to actual task completion, and improve integrity and non-repudiation of compensation between the client agent and participating autonomous agents. The technical advantage is automated, verifiable task-based settlement that ensures secure compensation of autonomous agents through cryptographically linked execution records, thereby improving integrity and non-repudiation of multi-agent service execution.

It will be appreciated that the cryptographically secured transaction is recorded as an immutable entry in the data store, wherein the immutable entry is stored using tamper-evident, append-only semantics. The transaction entry is cryptographically linked to the task completion record by computing a hash of the task completion record and storing the hash (and optionally a digital signature) with the transaction entry, and/or by storing a transaction identifier and hash pointer in the task completion record, such that any alteration causes a cryptographic mismatch and is detectable. This is performed to provide a verifiable settlement trail binding payment to confirmed task completion. The technical advantage is tamper-evident, non-repudiable auditability of task-based transactions through cryptographic linkage and immutable recording.

Optionally, the registry component is further configured to track task completion records for each autonomous agent stored in the database and compute a reputation score for each autonomous agent based on the tracked records. Tracking comprises linking task completion records stored in the data store to an agent identifier and maintaining per-agent aggregates in the registry database. Herein, the term “reputation score” refers to a quantitative performance metric associated with an autonomous agent, computed from historical task execution data to represent the reliability, efficiency, and effectiveness of the autonomous agent in performing assigned tasks. The reputation score is computed by the registry component using task completion records stored in a data store and linked to the autonomous agent. The computation may include aggregating one or more measurable performance indicators, including, but not limited to, at least one of: a number of successfully completed tasks, a task completion latency derived from recorded timestamps, a task success indicator derived from completion status fields in the task completion records. Optionally, the reputation score for each autonomous agent is stored as a representation in the data store, for example as a structured record linked to an agent identifier and updated upon re-computation. The orchestration module retrieves the reputation score for candidate autonomous agents from the data store and applies the reputation score as a weighted selection parameter, for example by computing a composite selection score that weights reputation together with capability match, pricing, and availability. This is performed to preferentially select higher-performing agents and improve reliability of task execution. The technical advantage is performance-aware agent selection that improves execution reliability by using reputation scores computed from verifiable task outcomes.

In some embodiments, the composition module applies access controls to the composite agent such that only autonomous agents associated with the objective are authorized to interact with the composite agent during task execution. The access controls may be enforced using objective-scoped allowlists, tokens/keys, or access control policies validated at runtime to reject interaction requests from non-associated agents. The technical advantage is improved execution security and isolation by limiting composite agent interactions to authorized task-assigned agents.

Optionally, the access controls for the composite agent are enforced using cryptographic keys, wherein the composition module issues each autonomous agent associated with the objective a respective cryptographic key authorizing interaction with the composite agent. The composite agent validates the cryptographic key before permitting invocation or data exchange, and autonomous agents not associated with the objective are denied access due to absence of a valid key. The technical advantage is objective-scoped, cryptographically enforced access control that improves execution security.

Optionally, the composition module is configured to generate an audit log of actions taken by the composite agent during execution of each task associated with the objective by capturing task execution events and storing corresponding log entries in a data store, wherein each entry comprises at least one of: a task identifier, an identifier of the autonomous agent that performed the task, and/or a timestamp for the task execution. This is performed to provide traceability and post-execution verification of multi-agent task performance. The term “audit log” refers to a machine-readable record that stores, for a service request, a chronological sequence of execution events indicating actions performed during task execution, optionally including task identifiers, performing agent identifiers, timestamps, and execution status. In some embodiments, the audit log is stored as an immutable record in the data store using append-only, tamper-evident storage semantics. The audit log is cryptographically linked to the composite agent by storing a composite-agent identifier with a cryptographic hash and/or digital signature computed over the audit log contents and the composite-agent identifier, such that any post-recordation modification causes a detectable cryptographic mismatch. This arrangement ensures integrity and verifiable provenance of composite-agent execution records. The term “task identifier” refers to a unique value (e.g., alphanumeric ID, hash, or GUID) assigned to a task specification to distinguish the task from other tasks and enable tracking. The term “identifier of the autonomous agent” refers to a unique value for the executing agent (e.g., agent ID in the registry, address, or public key) enabling attribution of the task to a specific autonomous agent and the term “timestamp for the task execution” refers to a recorded time value (e.g., start time and/or completion time) generated from a system clock or trusted time source to order execution events and derive latency metrics. The technical advantage the aforementioned approach is improved accountability and tamper-evident traceability of composite execution via structured audit logging.

It will be appreciated that the orchestration module is further configured to negotiate task execution by querying multiple candidate autonomous agents for execution terms. In this context, the orchestration module transmits to one or more autonomous agents capable of performing at least one task associated with the objective, a query requesting terms for performing the at least one task, wherein the query may be a structured message identifying the task, required inputs, constraints, and an expected output format. The orchestration module receives from each of the one or more autonomous agents, a respective offer comprising execution terms including at least one of a pricing parameter, an estimated completion time, or capability metadata, optionally in a schema-defined response object. The orchestration module then selects at least one autonomous agent by comparing the execution terms across the received offers, for example by filtering offers that fail capability requirements and ranking remaining offers based on cost and/or estimated completion time under objective constraints. The technical advantage is improved resource efficiency and service quality by selecting agents using competitive, comparable execution terms rather than static or arbitrary assignment.

Optionally, the orchestration module is further configured to transmit a list of the plurality of tasks associated with the objective to a device of a user, for example via a graphical user interface, a messaging interface, or an application programming interface, wherein the transmitted list includes task identifiers and human-readable task descriptions. The orchestration module is further configured to receive, from the device, an input indicative of at least one of: which tasks are to be executed and/or an order in which the tasks are to be executed, wherein the input may comprise selected task identifiers, reordered task identifiers, approvals, rejections, or constraint edits. The orchestration module then updates the execution plan based on the received input prior to generating task specifications and initiating execution. The technical advantage is improved execution accuracy and user-controlled task sequencing by incorporating explicit user validation into automated multi-step orchestration.

Optionally, the orchestration module monitors execution progress of each autonomous agent assigned to a task by receiving periodic status updates or evaluating execution time thresholds. If the orchestration module determines that an autonomous agent is unable to complete a task due to failure, timeout, or unavailability, the orchestration module transfers execution context associated with the task including task parameters, intermediate outputs, and state information to a second autonomous agent capable of performing the task. The second autonomous agent resumes execution using the transferred context, thereby preserving execution continuity. The technical advantage includes improved fault tolerance and execution resilience through dynamic agent handoff with state preservation.

Optionally, the orchestration module analyses task dependencies to identify independent sub-tasks and dispatches such independent sub-tasks to respective autonomous agents for concurrent execution. The composition module aggregates results returned from the autonomous agents and synthesizes the results into a unified service response. Parallel execution may be implemented using asynchronous messaging, distributed processing nodes, or parallel execution threads. The technical advantage is reduced service latency and improved scalability through concurrent multi-agent execution.

It will be appropriated that, optionally, communication between the orchestration module and autonomous agents occurs using a structured message format comprising predefined fields for task identifiers, execution parameters, context data, status indicators, and output results. The structured format may be schema-defined and serialized as a structured data object. This enables deterministic parsing, validation, and response generation across heterogeneous autonomous agents. The technical advantage of aforementioned approach is improved interoperability and reliable communication between distributed autonomous agents.

Optionally, the step of generating the objective (by the client agent) further comprises referring the service request to a large language model (LLM) configured to transform the service request into service data in the form of one or more representations stored in a data store and using the service data as the objective. In this context, referring comprises transmitting the service request, or a structured form thereof, to the LLM via an interface (e.g., an API call or inter-process message), and receiving from the LLM an output that encodes the request in a machine-processable format, such as a structured data object and/or an embedding vector suitable for storage and retrieval. The client agent stores the returned service data as one or more representations in the data store (optionally a vector database) and designates the stored service data as the objective provided to the orchestration agent for downstream task determination and execution. This is performed to convert unstructured natural-language requests into a normalized, context-preserving objective representation that can be programmatically processed for consistent task generation and autonomous agent coordination across multiple problem domains. The technical advantage is consistent and automated transformation of unstructured service requests into structured, machine-processable objective representations for reliable downstream task orchestration. Optionally, the system may be implemented using a distributed computing network architecture, a decentralized (i.e. distributed) computing network architecture, or a hybrid thereof. The term “distributed computing network architecture” refers to an arrangement in which system components, including agents, modules, and data stores, are deployed across multiple computing nodes that communicate over one or more networks, regardless of ownership or administrative domain. The term “decentralized computing network architecture” refers to an arrangement in which control or decision-making authority is not confined to a single central entity but may likewise be implemented across multiple computing nodes. The term “hybrid computing network architecture” refers to an arrangement or deployment that combines centralized and distributed and/or decentralized components within the same operational framework, without inherently limiting ownership or control unless expressly stated. For example, a centralized orchestration agent hosted in a cloud environment may coordinate autonomous agents operating on distributed user devices or enterprise servers, a registry component may be distributed across multiple geographic regions while task execution is performed by decentralized third-party agents, or a primary orchestration node may operate centrally with distributed backup nodes providing redundancy and failover support.

The system comprises the decentralized computing network that is configured to implement the software framework. Herein, the software framework encompasses any software abstraction which can have one or more software modules to provide generic and/or specific functionality (or specific functionalities). Optionally, the software framework is an agent framework. An agent framework may be a framework that enables the creation of application-specific AAs, an open economic framework (OEF) employing AAs, or a framework designed for developers (person or by artificial intelligence) to develop applications where both agents and a large language model are included in the application. For example, this may be a framework that is designed to simplify creation of applications using Large Language Models (LLMs). In this regard, the software framework is a specific implementation of the decentralized computing network, designed for the purpose of developing the AAs and for enabling the AAs to interact and transact with each other. The software framework provides the infrastructure and resources for the AAs to communicate, negotiate, and exchange value in a secure and transparent manner. Herein, the open economic framework refers to a computing framework that encompasses a discovery and incorporation of new micro-agents by using the Large Language Model (LLM) and enable the execution of tasks associated with the plurality of AAs within the software framework. Notably, the framework may provide a standard interface for the plurality of AAs, and a selection of the plurality of AAs to choose from.

Optionally, the decentralized computing network comprises a plurality of computing devices that are communicably coupled to each other. Optionally, each of the plurality of computing devices comprises at least one processor, at least one memory device, and a communication interface. Furthermore, the decentralized computing network is optionally implemented as a decentralized structured P2P (peer-to-peer) network of devices; alternatively, multi-layer communication networks are employed, wherein communication devices are migrated between the layers depending upon their technical functionality, reliability, peer-review assessment and/or trustworthiness. Specifically, the decentralized structured P2P network represents a decentralized computing environment within a P2P network.

Optionally, the software framework includes the plurality of AAs which are communicably interconnected using the decentralized computing network. Optionally, the plurality of AAs serves as a plurality of worker nodes of the decentralized computing network, for collectively fulfilling a plurality of AA-based functionalities belonging to the plurality of problem domains. The term “autonomous agents (AA)-based functionalities” as used herein refers to one or more functionalities of the AAs, that enable the AAs to serve the service request. Such functionalities may be, enabling digital payments, generating product recommendations, resolving customer queries, and the like. It will be appreciated that, unless explicitly stated otherwise, the terms “distributed”, “decentralized” and/or “hybrid” network architecture as used herein do not imply any particular ownership structure, control hierarchy, or administrative boundary, and should not be construed as limiting the system to single-owner, multi-owner, centralized, or federated deployments. The aforementioned computing network architectures ensure coverage of both centrally managed and multi-entity implementations while preserving architectural flexibility.

It will be appreciated that by providing the client-agent device (client-AA) as part of the software framework, the system enables users to interact with the plurality of AAs and utilize the capabilities of the software framework to accomplish various tasks and objectives. Herein, the software application refers to a modular and extensible software module that functions as an application programming interface (API). Typically, the application programming interface (API) is a set of rules and protocols that allows different software applications to communicate and interact with each other. Optionally, the software application within the client-agent device could be a chatbot that interacts with users through natural language processing. Optionally, the software application could be a task management application that allows users to create, assign, and track tasks. Optionally, the software application could function as a virtual assistant application that assists users with various tasks and provides personalized recommendations or services. Optionally, the software application could serve as an intelligent shopping assistant, and so forth.

The term “service request” as used herein refers to a specific action or communication made by a user, typically through a digitalized system, to seek a particular service or assistance. Optionally, the service request can take various forms, such as direct interactions with digital interfaces like voice assistants (such as Siri, Alexa, ChatGPT, and so forth), inputting information into dedicated applications, or entering appointments into personal calendars. Optionally, the service request may include metadata, which is additional information accompanying the request, and is utilized by the Large Language Model (LLM) to provide relevant inferences or responses. Optionally, the service request may originate from individuals or authorized entities, including the digital twins or company Large Language Models (LLMs) empowered to request services on behalf of the clients, such as arranging travel services.

In an embodiment, the service request includes at least one of a time needed for providing the service, a price associated with the service, a quality associated with the service, and/or at least one preference associated with the service. For example, the user specifies a parameter (such as, using the graphical user interface associated with client-agent device (client-AA)) including at least one of: time, price, quality and/or at least one preference that is required by the user in the provided service. In such an instance, the parameter is provided to the client-agent device (client-AA) with the generated service request. In one example, the service request includes the price associated with the service, such as a minimum and maximum price associated with the service.

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM).

In this regard, the service request can be received from the software application such as a mobile application or a desktop application installed or executed on the user's device. For example, a user using a travel planning application on their smartphone can make a service request to book a hotel.

Optionally, the service request can be received from a software application executing on the computing device such as a home automation hub that is communicably coupled to the user's device (such as a smartphone) through a wireless connection. In such a case, the user utilizes the software application on their smartphone to interact with and send service requests to the home automation hub, enabling the user to control and manage various aspects of a smart home environment. Optionally, the service request is received from the cloud-based software application such as Google Calendar.

Optionally, the service request can be received from the digital twin that refers to a virtual representation of a given user. It will be appreciated that a given digital twin is updated in real-life, from real-time data. Optionally, the given digital twin employs simulation, machine learning and reasoning to assist in decision-making. Typically, the given digital twin spans a lifetime of the given user, however, a lifetime of the given digital twin may vary based on requirements of the given user. Optionally, the given digital twin being the autonomous agent (AA) means that the given digital twin is capable of autonomously making decisions on behalf of the given user. Optionally, the digital twin could be a party sending the service request.

Optionally, the service request can be received from the digital representation of the user that refers to a computer-generated representation of the user. For example, the digital representation could be a chatbot or an avatar that interacts with the system on the user's behalf. For instance, a user's digital representation engaging in a virtual meeting and making a request for a presentation to be shared. Optionally, the service request can be received from the artificial intelligence model (AI-model) based on the Large Language Model (LLM) to generate natural language responses or carry out tasks. For example, a user interacting with a language-based AI assistant like ChatGPT to request information about nearby restaurants. Beneficially, the system can receive the service requests from diverse sources, including various software applications, cloud-based services, digital twins, digital representations, and AI models. This broadens the accessibility and flexibility of the system, allowing users to interact with the system through different channels or interfaces. Optionally, in task refinement the machine learning model agent (ML-Model AA) such as the Large Language Model (LLM) may be used to break down a given task into its sub-tasks or may provide alternatives or variants of doing the given task. The user may also provide the input for selection of a given alternative or variant from amongst the alternatives or variants provided.

The term “objective” as used herein refers to a desired outcome or goal that the client agent or the client-agent device (client-AA) aims to achieve based on the service request received therethrough. Optionally, the objective defines the purpose or intent behind the service request. In this regard, the objective is generated by the client-agent device (client-AA). The objective is typically formulated in a structured manner to provide clarity and guidance for the subsequent actions of the client-agent device (client-AA) and the plurality of AAs in the system. For example, the objective could be to book a flight to Paris, when the service request is to find and book a flight to Paris. In another example, the objective could be to schedule a meeting with an individual on a specific day. In yet another example, the objective could be to order groceries and deliver them by a specified date.

The term “one or more vectors” as used herein refers to a representation of data that describes or captures the objective associated with the service request. Typically, the vector is a mathematical construct that represents a quantity or a set of values in a multi-dimensional space. Optionally, the objective associated with the service request is represented as one or more vectors, which means that it can be expressed using multiple sets of values or dimensions. Each dimension in the vector represents a specific aspect or characteristic of the objective. The term “vector database” as used herein refers to a data storage system or structure that is designed to store and manage the one or more vectors. Optionally, the vector database employs embeddings that are generated by the Large Language Models and have a large number of attributes or features. Optionally, said features represent different dimensions of the data that are essential for understanding patterns, relationships, and underlying structures. Optionally, an embedding model may be used to create vector embeddings for the one or more vectors required to be index. Optionally, the embedding is inserted into the vector database, with some reference to the original content the embedding was created from.

For example, if the objective is to book a flight to Paris, it could be represented as a given vector with dimensions such as destination, departure date, return date, preferred airline, and class of service. Moreover, each dimension would have a corresponding value or range of values associated with it, providing a comprehensive description of the objective.

In this regard, advantageously, the vector database allows for fast and accurate similarity search and retrieval of data based on their vector distance or similarity. This means that instead of using traditional methods of querying databases based on exact matches or predefined criteria, you can use a vector database to find the most similar or relevant data based on their semantic or contextual meaning. The result of the similarity search and retrieval is usually a ranked list of vectors that have the highest similarity scores with the query vector. Optionally, the Large Language Model (LLM) is used to embed the context of the service request into a vector which is then used to query the vector database to find the list of vectors that have the similarity score above a threshold. Optionally, the Large Language Model (LLM) provides a list of such vectors that are associated with the task and ML model is used to select the best ones that match the criteria for the service. The effect of using a vector based lookup using vector database provides fast and more accurate similarity search compared to the exact matches search to find the list of tasks associated with the objective. The list of tasks provided by the vector database is a ranked list based on the similarity of the query vector.

Optionally, when generating the objective associated with the service request, the software application is configured to employ at least one data processing algorithm to match metadata associated with previous service requests with at least one service that is requested in the service request, and to transform matched content in the form of the one or more vectors recorded in the vector database. In this regard, the software application uses data processing algorithms to compare the metadata associated with at least one service that is requested in the service request (current) to the metadata from the previous service requests stored in the system. Examples of the data processing algorithms may include, but is not limited to, a text-based search, or lookup function, and so forth. The system allows to find similarities or relevant patterns between the current and the previous service requests. This process helps in identifying relevant historical data that can assist in generating the objective for at least one service that is requested in the service request. For example, suppose a user submits a service request to book a hotel in a particular city. The software application can compare the metadata of this request, such as the desired location, check-in/out dates, and preferred amenities, with previously recorded service requests. Moreover, once the software application identifies the previous service requests that match the metadata of at least one service that is requested in the service request, it extracts the relevant content from those matches. This content could include details like booking preferences, user feedback, or historical usage patterns. Optionally, the extracted content is then transformed into one or more vectors, which are recorded in the vector database. The transformation process involves converting the relevant information into a structured format that can be represented as a set of values across multiple dimensions. Each dimension represents a specific attribute or aspect of the matched content. Furthermore, as mentioned in the previous example, when the software application finds the previous service requests for hotel bookings in the same city. It extracts relevant details like preferred hotel chains, budget constraints, and user ratings. This extracted information is transformed into the one or more vectors that captures these dimensions, enabling efficient storage and retrieval of objective-related data in the vector database. This allows for improved personalization, efficiency, and relevance in fulfilling the service requests.

Optionally, when generating the objective associated with the service request, the software application is configured to:
refer the service request to a Large Language Model (LLM) for processing, wherein the Large Language Model (LLM) is configured to transform the service request into a service data associated with the service request, the service data being in a form of one or more vectors recorded in the vector database; and
use the service data received from the Large Language Model (LLM) as the objective.

Optionally, when generating the objective associated with the service request, the software application is configured to:
interact with the client to confirm on the objective and metadata associated with the objective of the service request.

In this regard, for example, suppose a user submits a service request to book a hotel in a particular city. Optionally, the software application is then configured to confirm from the client on the metadata associated with the service request such as hotel rating, booking price, desired location, check-in, check-in/out dates.

Optionally, the software application is further configured to interact with the client by presenting various objectives formulated and asking for confirmation from the client on one of the objectives that matches closely to the service requested by the client. Optionally, the client or the digital twin of client device may request to interact with the system to confirm on the metadata so that system is authorized to move to next step.

In this regard, the software application utilizes the Large Language Model (LLM) to process the service request. Notably, the Large Language Model (LLM) is an artificial intelligence model trained on a vast amount of textual data, enabling it to understand and generate human-like language responses. Moreover, when the software application refers the service request to the Large Language Model (LLM), it uses natural language processing techniques to analyze and interpret the service request. The Large Language Model (LLM) understands the context, identifies key information, and extracts relevant details from the service request. Moreover, once the Large Language Model (LLM) processes the service request, it transforms the extracted information into service data represented as the one or more vectors. The one or more vectors capture the essential characteristics or attributes of the service request in a structured format. For example, if the service request is to find a nearby restaurant, the Large Language Model (LLM) can extract information such as the desired cuisine, location, price range, and any specific dietary restrictions. This information is then converted into a vector representation with each dimension representing a specific attribute (such as cuisine, location, price, and so forth).

Furthermore, the service data, in the form of one or more vectors, generated by the Large Language Model (LLM) is used as the objective associated with the service request. It becomes the refined and structured representation of the user's request, suitable for further processing within the system. For instance, the transformed service data vector may be used by other AAs in the system to match the user's preferences with available restaurants, recommend suitable options, or make decisions based on the extracted attributes. The technical effect of referring the service request to the Large Language Model (LLM) is that it allows for efficient storage, retrieval, and manipulation of the objective within the system, enhancing the system's ability to understand and fulfil the user requests accurately and effectively.

Optionally, the Large Language Model (LLM) is at least one of: an internal Large Language Model (Internal-LLM) of the client-agent device (client-AA), an external Large Language Model (External-LLM) of or associated with the agent-device (AA or micro-AA).

In this regard, optionally, the system may utilize either the internal Large Language Model (Internal-LLM) or the external Large Language Model (External-LLM) for processing the service requests and generating the objectives. Optionally, the internal Large Language Model (Internal-LLM) is used when there is sufficient contextual information available within the system, while the external Large Language Model (External-LLM) is employed when additional information or comprehensive language processing capabilities are required. This flexibility allows the system to efficiently handle a wide range of the service requests and provide accurate and relevant objectives to fulfil the user needs.

Optionally, the client-agent device (client-AA) may check if there is a previous task or the service request that contains enough steps (subtasks) with most of the necessary context. If such a task is found, it means that the user has previously requested a similar service. The client-agent device (client-AA) can refer to the internal Large Language Model (Internal-LLM), which is part of the client-agent device (client-AA), to retrieve the necessary contextual information. For example, if the user had previously requested a similar travel arrangement to London, the client-agent device (client-AA) can refer to the internal Large Language Model (Internal-LLM) to retrieve the previously stored context, such as preferred transportation options, accommodation choices, and relevant weather information.

Optionally, when there is no previous task that contains sufficient contextual information, or if the Large Language Model (Internal-LLM) does not have the necessary data, the client-agent device (client-AA) needs to refer to the external Large Language Model (External-LLM). Optionally, the external Large Language Model (External-LLM) could be a well-known model like ChatGPT, Amazon Alexa, or similar LLMs that provide comprehensive language processing capabilities. In such cases, the client-agent device (client-AA) sends the service request or relevant details to the external LLM, which processes the information, understands the context, and generates the objective or provides additional information required to fulfil the user's request. Optionally, the client agent interacts with the client to confirm on one of the formulated objectives and the metadata associated with the objective. The external LLM assists in handling the complex language understanding and contextual reasoning aspects of the service request. The client-agent device (client-AA), as the initial point of interaction with the user, generates the objective based on the service request. The client-agent device (client-AA) then passes the objective to the agent-device, which can be a specialized micro-AA or a more comprehensive AA, responsible for executing specific tasks or managing specific domains within the system. This allows for efficient division of labor and facilitates the seamless processing and execution of the service requests.

The term “context-builder software module” as used herein refers to a component of the agent-device (AA or micro-AA) within the system. It is responsible for building the context necessary to execute tasks associated with the objective received from the client-agent device (client-AA). In this regard, upon receiving the objective, the context-builder software module sends one or more queries to the machine learning model agent (ML-Model AA). The machine learning model agent (ML-Model AA) could be an autonomous agent that specializes in machine learning tasks and has the ability to provide insights and information based on previous queries or experiences. Optionally, the context-builder software module is communicably coupled with a platform which enables creation, testing, development, deployment and management of autonomous agents. Optionally, the platform is also communicably coupled to the vector database. Optionally, the platform could be an agentverse which is a tool that serves as a portal to the broader agent-based software frameworks and toolsets. Optionally, the platform provides a library of pre-built agents, an analytics dashboard, and an intuitive interface, making it a powerful platform for creating intelligent software AAs.

Optionally, the machine learning model agent (ML-Model AA) is at least one of: an internal Large Language Model (Internal-LLM) of the agent-device (AA or micro-AA), an external Large Language Model (External-LLM) associated with the agent-device (AA or micro-AA). In this regard, the machine learning model agent (ML-Model AA) is capable of performing tasks related to language understanding and processing by transforming the service request or the objective into service data in the form of the one or more vectors recorded in the vector database. It will be appreciated that the system allows for flexibility in the selection of the machine learning model agent (ML-Model AA) by providing options for both the internal Large Language Model (Internal-LLM) and the external Large Language Model (External-LLM). Moreover, depending on the specific implementation or configuration, the machine learning model agent (ML-Model AA) can be either the internal Large Language Model (Internal-LLM) residing within the agent-device (AA or micro-AA) or the external Large Language Model (External-LLM) associated with the agent-device.

For example, the service request to find information about a specific topic is received by the client-agent device (client-AA). The ML-Model AA, acting as a language model, receives the objective and processes the objective using its natural language processing capabilities. If the internal Large Language Model (Internal-LLM) is employed, it performs the necessary computations and transforms the request into the service data internally within the agent-device. On the other hand, if the external Large Language Model (External-LLM) is used, the objective is sent to the associated external model, which processes the request and provides the required service data back to the agent-device.

The context-builder software module is configured to access the vector database, which contains one or more vectors recorded in it. The context-builder software module retrieves tasks associated with the previous queries from the vector database to obtain the plurality of tasks associated with the objective. Optionally, by accessing the vector database, the context-builder software module gathers relevant information and tasks that are similar or related to the current objective. Optionally, by retrieving previous tasks associated with similar queries or objectives, the context-builder software module enhances the understanding of the current objective and enables the system to provide more accurate and relevant responses or actions.

Optionally, the context-builder software module engages in a dynamic exchange of information with the machine learning model agent (ML-Model AA) to determine the sequence or prioritization of tasks. For example, when the objective is to plan a vacation, and there are multiple tasks involved, such as booking flights, reserving accommodation, and arranging transportation. In such a case, the context-builder software module communicates with the machine learning model agent (ML-Model AA) to obtain insights and recommendations on the optimal order in which these tasks should be executed. Moreover, the machine learning model agent (ML-Model AA) might provide recommendations based on factors like availability, cost, or user preferences.

Optionally, the context-builder software module also interacts with the machine learning model agent (ML-Model AA) to obtain the list that includes multiple autonomous agents (AAs or micro-AAs) associated with the objective and can contribute to its execution. For example, the machine learning model agent (ML-Model AA) provides the list of autonomous agents associated with the objective, which helps in assembling a team of agents capable of handling different tasks related to the vacation planning process.

Optionally, the order of tasks associated with the objective of service request is validated by communication with the Large Language Models (LLM). Optionally, the agent uses a Large Language model (LLM) to determine the list of tasks and order of tasks to be executed to fulfil the service request. In this regard, the large language model (LLM) is a deep learning algorithm trained on a large number of unlabeled datasets. The plurality of agents uses the Large Language model (LLM) to gather information about the tasks to be executed and the order of execution of tasks. Further, for each agent when using the Large Language model (LLM), the external ML module can be a Generative Pre-trained Transformer (GPT) such as a ChatGPT (ChatGPT is a registered trade mark) but not limited to. In this regard, when a new service request is received, the Large Language model (LLM) provides a recommendation on how the given agent can be composed of existing autonomous agents to execute the list of recommended tasks and the reusability of given autonomous agents or of composed given autonomous agents. The reusability and compositions of the plurality of autonomous agents reduce the use of computation resources required to fulfil the service request. Moreover, the reusability makes the development and expansion of the system's functionality time-efficient since it reduces or removes the need for re-programming. Furthermore, the composition and reusability of autonomous economic agents or composed autonomous agents provides a way to handle any complex action by using existing protocols without the need to start from scratch thus reducing the use of computational resources.

Optionally, the list including the plurality of autonomous agents that are associated with the objective, is generated using a registry component and a search and discovery component, wherein the registry component comprises a database of autonomous agents and their components, and wherein the search and discovery component is configured to find, using the database, the at least one autonomous agent which is capable of performing the at least one task.

Herein, the registry component and the search and discovery component refer to software components. Optionally, the registry component serves as the database that stores information about autonomous agents and their components. The database contains details such as agent capabilities, skills, protocols, and connections. Optionally, the registry component acts as a centralized repository where information about available autonomous agents is maintained. Optionally, the search and discovery component is responsible for finding the at least one autonomous agent that are capable of performing the specific task(s) associated with the objective. Optionally, the search and discovery component utilizes the registry component's database to search for suitable agents based on their capabilities and characteristics.

In an example, when the objective is to find a suitable autonomous agent for flight booking. The search and discovery component would query the registry database to find autonomous agents that have the necessary components related to flight booking, such as flight search skills, flight booking protocols, and connections to airline reservation systems. The search and discovery component uses the information stored in the registry component's database to identify the autonomous agent(s) that meet the criteria for flight booking tasks.

Optionally, by combining the capabilities of the registry component (which stores information about autonomous agents and their components) and the search and discovery component (which searches the registry database for suitable agents), the system generates the list of autonomous agents associated with the objective. This list ensures that only the agents capable of performing the specific task(s) are included, enabling efficient task allocation and execution.

Optionally, the components of the autonomous agents comprise at least one of: skills, protocols, connections, of the autonomous agents. Herein, the skills refer to the specific abilities or expertise possessed by the autonomous agent. Moreover, the skills define what tasks the autonomous agent is proficient in performing. For example, the autonomous agent specialized in flight booking would have the skill to search for flights, compare prices, and make bookings. Herein, the protocols represent the predefined rules or procedures that autonomous agents follow to execute tasks. Moreover, the protocols define how the agent interacts with other components or entities involved in the task execution process. For instance, the autonomous agent involved in hotel reservation might have the protocol for communicating with hotel booking systems and processing reservation requests. Herein, the connections refer to the interfaces or integrations that autonomous agents have with external systems or services. Moreover, the connections enable seamless communication and data exchange between the agent and external entities. For example, the autonomous agent responsible for transportation arrangements may have connections with ride-sharing services, public transportation systems, or car rental companies.

It will be appreciated that by considering the skills, the protocols, and the connections, the system can assess the capabilities of the autonomous agents listed in the registry database. This information helps in identifying the most suitable agents for performing the tasks associated with the objective, ensuring effective and efficient fulfilment of the service request.

Furthermore, once the list of associated autonomous agents is obtained, the context-builder software module blocks communication signals between the client-agent device (client-AA) and autonomous agents that are not associated with the objective. This ensures that only the relevant agents receive and process the communication signals related to the objective, optimizing the system's performance and resource utilization. Additionally, the context-builder software module is responsible for associating at least one autonomous agent from the list of associated agents with each task related to the objective. Moreover, the context-builder software module ensures that there is a proper mapping between tasks and the autonomous agents, ensuring that each task is assigned to at least one autonomous agent associated with the objective. This association enables effective task allocation and execution within the system.

Optionally, by interacting with the machine learning model agent (ML-Model AA), the context-builder software module effectively manages the autonomous agents associated with the objective. It obtains a relevant list of agents, blocks communication signals to non-associated agents, and associates tasks with the appropriate agents. This allows for efficient coordination and execution of tasks within the system, ensuring that the objective is accomplished effectively and in a timely manner.

The software framework includes the domain-independent protocol specification language. The term “domain-independent protocol specification language” as used herein refers to a formal language that enables the definition of protocols for interactions across the plurality of problem domains. In this regard, the domain-independent protocol specification language is used to describe the format, structure, and rules for communication between at least one autonomous agent, between the client-agent device (client-AA) and the agent-device (AA or micro-AA) and between the plurality of AAs and the plurality of computing devices communicably coupled with the decentralized computing network, regardless of the specific application domain or context. It will be appreciated that the domain-independent protocol specification language provides a standardized way of defining protocols that enables interoperability and seamless communication among the plurality of AAs in the system, regardless of the domain thereof. Moreover, the domain-independent protocol specification language in the software framework promotes fairness, transparency, and efficiency in the system. Furthermore, the domain-independent protocol specification language enables the system to become scalable for providing multi-domain services.

Optionally, the domain-independent protocol specification language is stored in a form of a set of instructions, in at least one memory device of the decentralized computing network. Optionally, the domain-independent protocol specification language is stored on the at least one memory device in a manner that makes it easily accessible to the plurality of AAs. Optionally, the at least one memory device may be a physical memory device, such as a hard drive or a flash drive, or a virtual memory device, such as a cloud-based server. Optionally, the domain-independent protocol specification language could also be stored on a cloud-based memory. Optionally, the cloud-based memory is communicably coupled to the decentralized computing network. Furthermore, storing the domain-independent protocol specification language in the form of the set of instructions promotes interoperability, standardization, and reliability in the decentralized computing network, and supports the smooth functioning thereof. It will be appreciated that said set of instructions is well defined and thus could be easily used for defining various types of protocols.

The software framework includes a protocol generator. The term “protocol generator” as used herein refers to a software tool that generates protocol(s) for AAs using the domain-independent protocol specification language. The term “protocol” as used herein refers to an implementation of the rules and guidelines described in a protocol specification. In other words, the at least one protocol is one of the critical building blocks and abstractions that define communications of the client-agent device (client-AA). The at least one protocol of the client-agent device (client-AA) defines interactions of the client-agent device (client-AA) with other AAs amongst the plurality of AAs, and with the plurality of computing devices. Moreover, the at least one protocol defines how messages are encoded for a transportation thereof. Optionally, the at least one protocol includes constraints or conditions to ensure that a certain message sequence follows a specific pattern. For example, a “SELL” message must follow a “BUY” message, and a “FINISH” message must follow a “START” message. This means that the client-agent (client-AA) will only be able to “SELL” or “FINISH” if the appropriate preceding message (BUY or START) has been sent. Additionally, such constraints help to maintain the consistency and integrity of the communication between the plurality of AAs. It will be appreciated that the protocol generator enables streamlining the development process of the client-agent device (client-AA), reduces the risk of errors in the interactions of the client-agent device (client-AA), and ensures that the at least one protocol is consistent and well-defined. Optionally, the at least one protocol pertains to interactions of the client-agent (client-AA) across the plurality of problem domains. In this regard, the domain-independent specification language enables the definition of protocols for interactions across the plurality of problem domains. This means that in such a case any protocol could enable the client-agent device (client-AA) to interact for addressing the service requests from the plurality of problem domains.

The term “build executor software module” as used herein refers to a component within the software framework that is specifically designed to handle the composition and execution of tasks within the system. Optionally, the build executor software module plays a crucial role in coordinating and managing the workflow of AAs and their associated tasks. The build executor software module is responsible for composing each task associated with the objective in a specific order. Optionally, the build executor software module ensures that the tasks are organized and arranged according to a predefined sequence or priority. This ordering ensures that tasks are executed in a logical and efficient manner, considering any dependencies or requirements between them.

Moreover, the build executor software module also composes each autonomous agent (AA) associated with the objective into a further autonomous agent (further-AA). The autonomous agent (further-AA) can be understood as a composite autonomous agent (composite-AA) or the composite agent (composed by the composition module) that combines the capabilities and functionalities of the individual AA(s) associated with the objective. Furthermore, to maintain the security and integrity of the system, the build executor software module encrypts access to the further autonomous agent (further-AA). Optionally, by encrypting the access, it ensures that unauthorized entities cannot tamper with or manipulate the further-AA. This security measure safeguards the execution of tasks and protects the system from potential threats or unauthorized access. Optionally, the step of encrypting the access to the further autonomous agent (further-AA) need not necessarily be implemented in all embodiments of the present disclosure. In other words, such encryption may be performed only optionally.

The further autonomous agent (further-AA), which is a composite of the autonomous agent(s) associated with the objective, is configured to implement the at least one protocol specification generated by the system. This further-AA executes each task associated with the objective based on the defined protocol specification. By doing so, it automatically executes the service request, carrying out the necessary actions or operations to fulfil the objective.

Optionally, the composability of tasks is how the tasks are combined to fulfil a complex service request. Optionally, the further autonomous agent (further-AA) is a combination of two or more autonomous agents to perform complex action. Optionally, when an existing agent cannot be used to perform the task associated with the objective of service, a new agent is created. Optionally, the AAs not associated with the objective and not participating in the fulfilment of service request are communicatively blocked from the client agent device via use of encryption keys. Such use of encryption keys provides a way to secure the system from access by a malicious external party. Such a system employing the build executor software module provides the advantages similar to the decentralized system wherein the new agent is only created when existing agents are not capable of performing the tasks associated with the objective and creation of new agent is validated by communication with the Large Language Models (LLMs) and/or ML model. Optionally, the validation is also done by association with a task associated with the objective of service request upon confirmation of availability to perform a task under time, cost consideration etc. As in the blockchain decentralized system, a new block is created only after the authenticity of transaction is validated by blockchain network. In the system proposed, creation of new agent is validated by the Large Language Model (LLM) and/or ML models and the agents communicate within themselves using peer to peer encrypted communication. The autonomous agents participating in execution of tasks associated with the objective of service request use encryption methods to communicate within themselves and other autonomous agent (AA) who are not participating in the tasks of the service request are blocked from communication to prevent any third-party access.

Optionally, the creation of new agent is treated as a block of a blockchain network, and after validation by the ML model and/or LLM and/or by existing agents using association with a task, each new agent created is appended to the chain of agents just like new block is connected to the existing blocks of a blockchain. Similar, to the blockchain network, once an agent has been created after validation, our system will have an agent holding the transaction information such as metadata associated with the task. The technical effect of treating the agents as blocks of blockchain is that the proposed system provides a way such that tampering with the functioning of agent can be avoided as it is almost impossible to modify the block once the transaction has been validated. With such a system, the service tasks are performed as planned and third-party attacks can be avoided. New agents created are cryptographically linked together just like blocks of a blockchain and are immutable, the functioning of agents cannot be altered. The proposed system provides a secure and transparent way to automatically execute the service request.

Optionally, the context-builder software module is further configured to
send a list of the plurality of tasks associated with the objective, to a device of a user; and
receive, from the device, an input provided by the user, wherein the input is indicative of at least one of: which tasks amongst the plurality of tasks are to be executed, an order in which each task amongst said tasks is to be executed.

In this regard, the user can receive the list of tasks on their device from the context-builder software module. Optionally, the device could be a computer, smartphone, or any other suitable device. Moreover, the context-builder software module is configured to receive the input provided by the user from the device. Optionally, the user can provide input indicating which specific tasks from the list they want to execute. This allows the user to select the tasks that are most relevant or important to them. Optionally, the user can also provide input specifying the order in which they want the selected tasks to be executed. This allows the user to define the sequence in which the tasks should be carried out, based on their preferences or requirements. Optionally, by enabling this functionality, the context-builder software module facilitates user interaction and customization within the system. The user can have a more active role in determining which tasks should be executed and in what order, tailoring the execution process according to their specific needs or priorities. This user input helps to provide a more personalized and flexible experience within the system.

In an implementation, the at least one task is defined by a JavaScript Object Notation (JSON) object, for example:

```
{ “id”: “task1”,
  “name”: “Search flight offers”,
    “description”: “This task can search for flight offers from a given airport to a
given destination airport. It returns a list of flights. ”,
  “schema”: { “type”: “flight”, “args”: {
        “from”: “Type is string, this field is the airport code for of the airport from
where the user wants to fly from. This should be airport IATA code.”,
        “to”: “Type is string, this field is the airport code of the destination airport!
This should be airport IATA code.”,
      “trip”: “This can be oneway or return”,
      “date”: “Type is string, contains the date of flying out.”,
        “back_date”: “Type is string, optional field only for return flight. This is the
date when the user wants to fly back”,
        “route”: “Type is number, selects the maximum number of stops, 0 means
direct flight, 1 means with maximum 1 stop. Defaults to 0.”,
          “persons”: “Type is integer, describes how many persons are going to fly,
defaults to 1”
    } } }
```

Optionally, from the task definition, description and key, values are concatenate from ‘schema.args’ to build a full task description. Optionally, using the Large Language Model (LLM) the at least one text is embedded into a high dimensional space (referred as an embedding space). Task id, embedding and the whole task definition is added to the vector database. Optionally, given a user objective, user objective text is embedded into the embedding space, and then using the vector database search, the at least one task which are related to the objective are found. Optionally, given the list of tasks for the given objective, tasks are executed one by one in the order. Optionally, the task execution means a data JSON containing fields defined by ‘schema.args’ is built. Optionally, upon receiving the data object, the plurality of autonomous agent (AA) may perform the work defined by the task. Optionally, an execution agent is defined which is prompting the LLM to execute the given task defined by text generated by the Large Language Model (LLM) in the task_creation_agent step. When this is executed the Large Language Model (LLM) outputs text, and then this output and original info about the task is put into the vector database, for using the previously executed tasks as context for the next step. Moreover, the context is provided into the Large Language Model (LLM) prompt, the vector database is used for finding the tasks related to the objective.

Optionally, when executing the tasks, a modified version of a React framework may be used. In the executor system the possible actions are the following:
(1) SearchTask[query; context], which searches for tasks in the vector database using natural language query to find tasks which can provide missing information given the context
(2) Ask[question; options], which asks for more information or asks for confirmation. If the option is provided as a comma separated list, then AI can ask for the user to for extra information.
(3) Finish[status; data], which returns the json formatted data according to the task schema and finishes the task.

The present disclosure also relates to the method as described above. Various embodiments and variants disclosed above apply mutatis mutandis to the method.

Optionally, the step of generating the objective associated with the service request comprises employing (i.e. executing) at least one data processing algorithm to match metadata associated with previous service requests with at least one service that is requested in the service request, and transforming matched content in the form of the one or more vectors recorded in the vector database.

Optionally, the step of generating the objective associated with the service request comprises:
referring the service request to a Large Language Model (LLM) for processing, wherein the Large Language Model (LLM) implements a step of transforming the service request into a service data associated with the service request, the service data being in a form of one or more vectors recorded in the vector database; and
using the service data received from the Large Language Model (LLM) as the objective.

Optionally, the Large Language Model (LLM) is at least one of: an internal Large Language Model (Internal-LLM) of the client-agent device (client-AA), an external Large Language Model (Internal-LLM) of or associated with the agent-device (AA or micro-AA).

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM).

Optionally, the machine learning model agent (ML-Model AA) is at least one of: an internal Large Language Model (Internal-LLM) of the agent-device (AA or micro-AA), an external Large Language Model (Internal-LLM) associated with the agent-device (AA or micro-AA).

Optionally, the method further comprises:
sending, from the context-builder software module, a list of the plurality of tasks associated with the objective, to a device of a user; and
receiving, at the context-builder software module, an input provided by the user, from the device, wherein the input is indicative of at least one of: which tasks amongst the plurality of tasks are to be executed, an order in which each task amongst said tasks is to be executed.

Optionally, the list including the plurality of autonomous agents that are associated with the objective, is generated using a registry component and a search and discovery component, wherein the registry component comprises a database of autonomous agents and their components, and wherein the search and discovery component implements a step of finding, using the database, the at least one autonomous agent which is capable of performing the at least one task.

Optionally, the components of the autonomous agents comprise at least one of: skills, protocols, connections, of the autonomous agents.

### DETAILED DESCRIPTION OF THE DRAWINGS

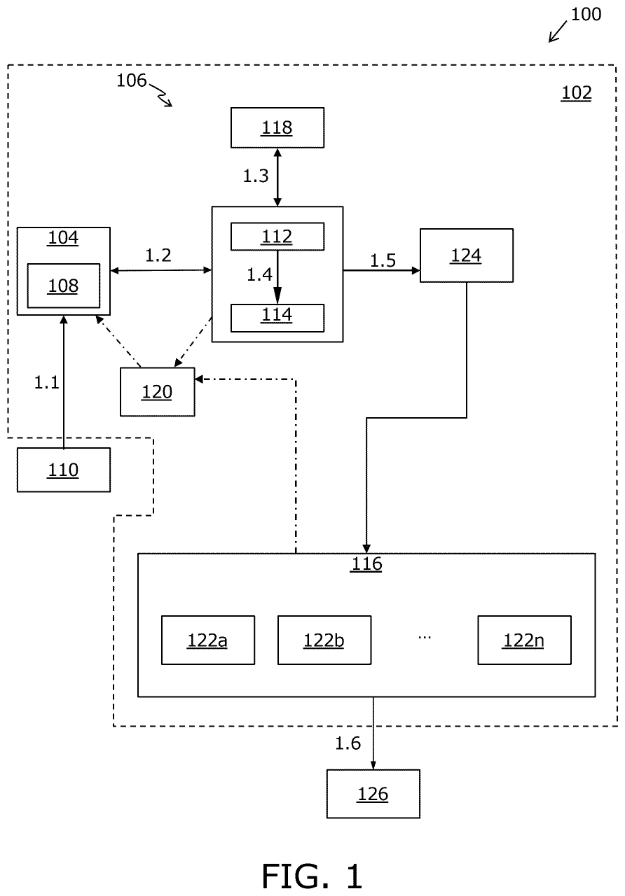

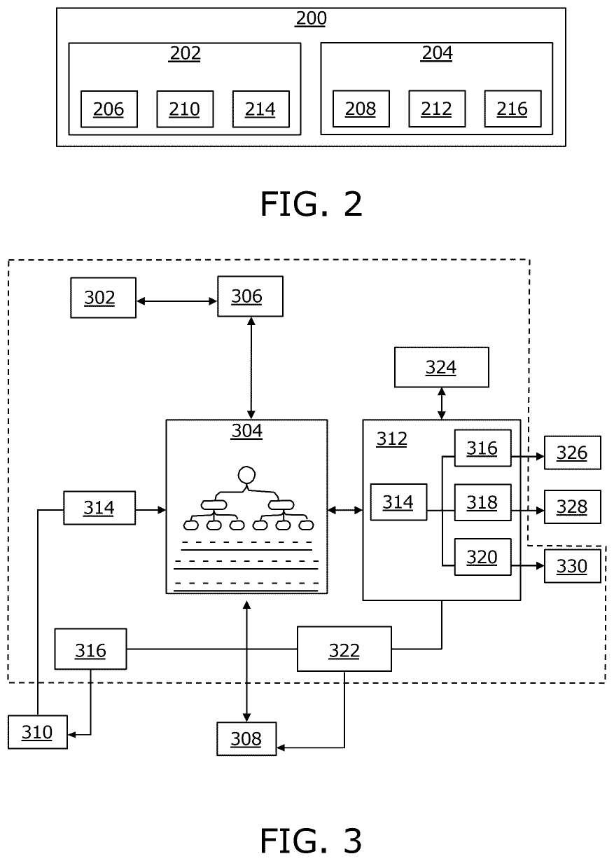

Referring to FIG. 1, illustrated is a block diagram of a system 100 that enables application of AAs across a plurality of problem domains, in accordance with an embodiment of the present disclosure. The system 100 comprises a decentralized computing network (shown in FIG. 2) configured to implement a software framework 102, wherein the software framework 102 comprises a plurality of modular and extensible software modules configured to operate as a plurality of AAs comprised within a plurality of computing devices (shown in FIG. 2). The plurality of AAs is communicably coupled with each other, as shown.

The software framework 102 comprises a client-agent device (client-AA) 104, and an agent-device 106. The client-agent device (client-AA) 104 comprises a software application 108. The software application 108 is configured to receive a service request (at 1.1) and to generate an objective associated with the service request, wherein the objective is in a form of one or more vectors recorded in a vector database, and to send (at 1.2) the objective to the agent-device (AA or micro-AA) 106. The service request may be received, for example, from a software application 110 executing on a device of a user. The service request may be received from other software elements too. The agent-device (AA or micro-AA) 106 comprises a context-builder software module 112, a protocol generator software module 114, and a build executor software module 116.

The context-builder software module 112 is configured to, upon receiving the objective, send one or more queries to a machine learning model agent (ML-Model AA) 118 and/or to access the vector database to retrieve one or more tasks associated with previous queries in order to obtain a plurality of tasks 120 associated with the objective. The context-builder software module 112 is further configured to interactively communicate with the machine learning model agent (ML-Model AA) 118 to obtain an order in which each task is to be executed. The context-builder software module 112 is further configured to interactively communicate with the machine learning model agent (ML-Model AA) 118 to: obtain a list including a plurality of autonomous agents (AAs or micro-AAs) 122a, 122b, . . . , 122n (collectively referenced as 122, for sake of simplicity only) that are associated with the objective, block communication signals between the client-agent device (client-AA) 104 and autonomous agents which are not associated with the objective, to associate at least one autonomous agent from the plurality of autonomous agents 122 associated with the objective with at least one task and such that each task is associated with at least one autonomous agent associated with the objective. Such interactions between the context-builder software module 112 and the machine learning model agent (ML-Model AA) 118 are represented by 1.3.

The protocol generator software module 114 comprises a domain-independent protocol specification language which, upon receiving (at 1.4) an invocation from the context-builder software module 112, is configured to generate (at 1.5) at least one protocol specification 124 for the execution of each task by the at least one autonomous agent associated with the task, wherein the protocol specification 124 is generated using the domain-independent protocol specification language.

The build executor software module 116 is configured to compose the at least one task in an order defined for each task to be executed, to compose each autonomous agent associated with the objective into a further autonomous agent (further-AA) 124, and to encrypt access to the further autonomous agent 126 to prevent tampering. Such compositions and encryption steps are represented by 1.6. The further autonomous agent (further-AA) 126 is configured to implement the at least one protocol specification 124 to execute each task associated with the objective and thereby automatically execute the service request.

Referring to FIG. 2, illustrated is an architecture of a decentralized computing network 200 of the system 100 of FIG. 1, in accordance with an embodiment of the present disclosure. The decentralized computing network 200 is configured to implement the software framework 102 of FIG. 1. As shown, the decentralized computing network 200 comprises a plurality of computing devices (depicted as computing devices 202 and 204). Each of the computing devices 202 and 204 comprises, for example, at least one processor 206 and 208, at least one memory device 210 and 212, and a communication interface 214 and 216, respectively.

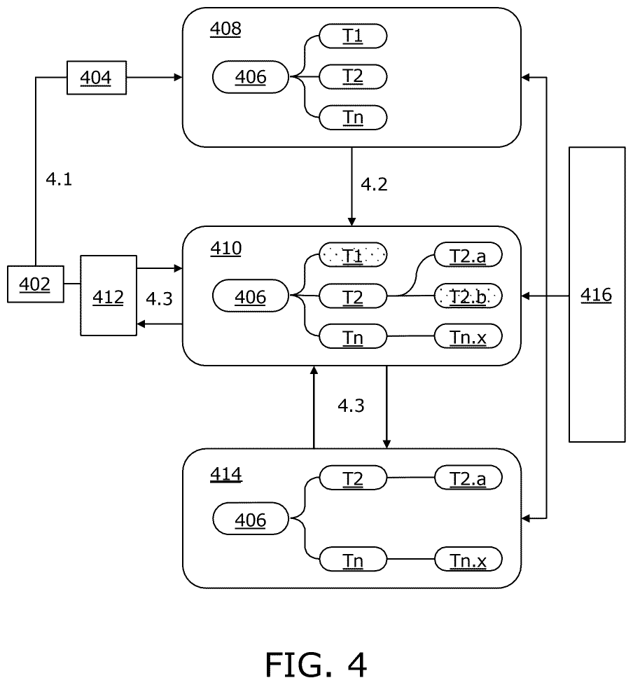

Referring to FIG. 3, illustrated are technical building blocks of the system 100 of FIG. 1, in accordance with an embodiment of the present disclosure. A software product 302 (such as a software application, a digital twin, a software model, or similar) is communicably coupled with a context-builder software module 304, via an application programming interface 306. The context-builder software module 304 is communicably coupled with a machine learning model agent (ML-Model AA) 308, a vector database 310, and a platform 312 which enables creation, testing, development, deployment and management of autonomous agents. The platform 312 is also communicably coupled to the vector database 310.

The context-builder software module 304 receives embeddings 314 from the vector database 310, such embeddings 314 including one or more tasks associated with previous queries. The context-builder software module 304 interactively communicates with the machine learning model agent (ML-Model AA) 308 to obtain an order in which each task is to be executed, to obtain a list including a plurality of autonomous agents (AAs or micro-AAs) that are associated with the objective, to block communication signals between a client-agent device (client-AA) and autonomous agents which are not associated with the objective, and to associate at least one autonomous agent from the plurality of autonomous agents associated with the objective with at least one task and such that each task is associated with at least one autonomous agent associated with the objective.

The platform 312 includes agent discovery metadata 314 and autonomous agents (depicted, for example, as autonomous agents 316, 318, and 320). A backend 322 of a registry component and a search and discovery component provides embeddings 316 for storing in the vector database 310. The platform 312 supports Agent DNS style search 324. For example, the autonomous agents 316, 318, and 320 are communicably coupled via application programming interfaces 326, 328, and 330, to an external system or an application, a machine learning inference model, and a co-learning software module, respectively.

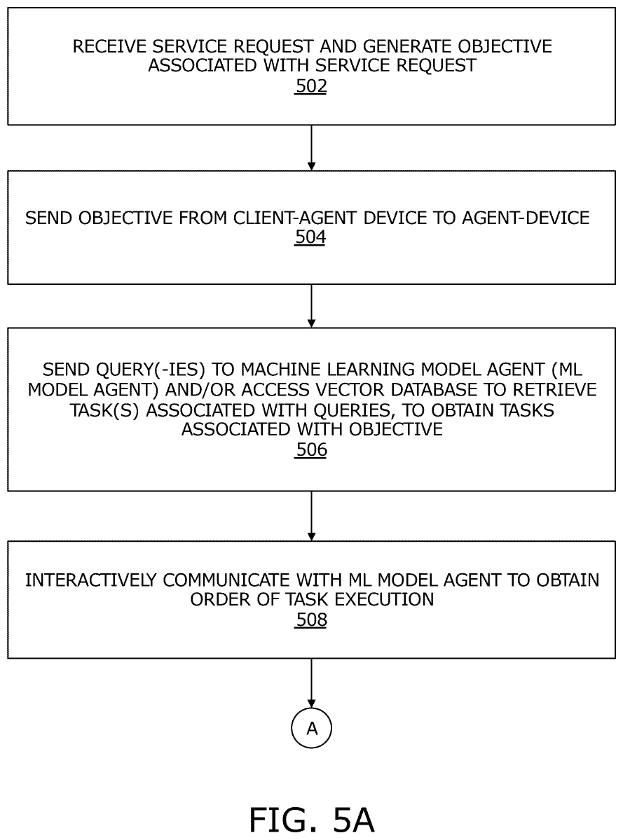

Referring to FIG. 4, illustrated is a schematic illustration of journey of a user 402 when the user 402 uses the system 100 of FIG. 1, in accordance with an embodiment of the present disclosure. A software product used by the user 402, or representing the user 402, or similar, sends at 4.1 a service request 404 to a client-agent device (client-AA). The service request 404 is used to generate an objective 406 and may also include an initial context related to the service request 404. The initial context could be some information related to the user 402. The objective 406 is used for task building 408. Simply put, the objective 406 is split into a plurality of tasks (represented as T1, T2, . . . , Tn) associated therewith. Next at 4.2, a list of the plurality of tasks T1, T2, . . . , Tn associated with the objective 406, may be sent to a device of the user 402, and the user 402 may provide an input, wherein the input is indicative of at least one of: which tasks amongst the plurality of tasks T1, T2, . . . , Tn are to be executed, an order in which each task amongst said tasks is to be executed. This part of the user's journey may be understood to be task refinement 410. For example, the user may remove the task T1 from amongst the plurality of tasks T1, T2, . . . , Tn that are to be executed. In task refinement 410, a machine learning model agent (ML-Model AA) such as a Large Language Model (LLM) may be used to break down a given task (such as the task T2) into its sub-tasks or may provide alternatives or variants (depicted as alternatives or variants T2.a and T2.b) of doing the given task. The user may also provide the input for selection of a given alternative or variant (for example such as T2.a) from amongst the alternatives or variants T2.a and T2.b provided. The task Tn may have only one alternative or variant such as Tn.x. Rejected tasks T1 and T2.b are shown, for example, using dotted hatches. Provision of the input by the user 402 for selection 412 may also be accompanied by the user 402 giving more context. Upon implementation of the task refinement 410, machine-readable inputs relating to the selected tasks T2 and Tn are created for autonomous agents. At 4.3, task execution 414 is performed. The step 4.3 may involve communication between two or more of at least one autonomous agent that is capable of performing at least one task from amongst the plurality of tasks, a context-builder software module, the machine learning model agent (ML-Model AA), and the user 402, and thus is depicted at two places in FIG. 4. When the tasks T2 and Tn are executed (and specifically, when the tasks T2.a and Tn.x are executed) by the at least one autonomous agent, the service request is fulfilled. The steps of task building 408, task refinement 410, and task execution 414 utilize a platform 416 which enables creation, testing, development, deployment and management of autonomous agents.

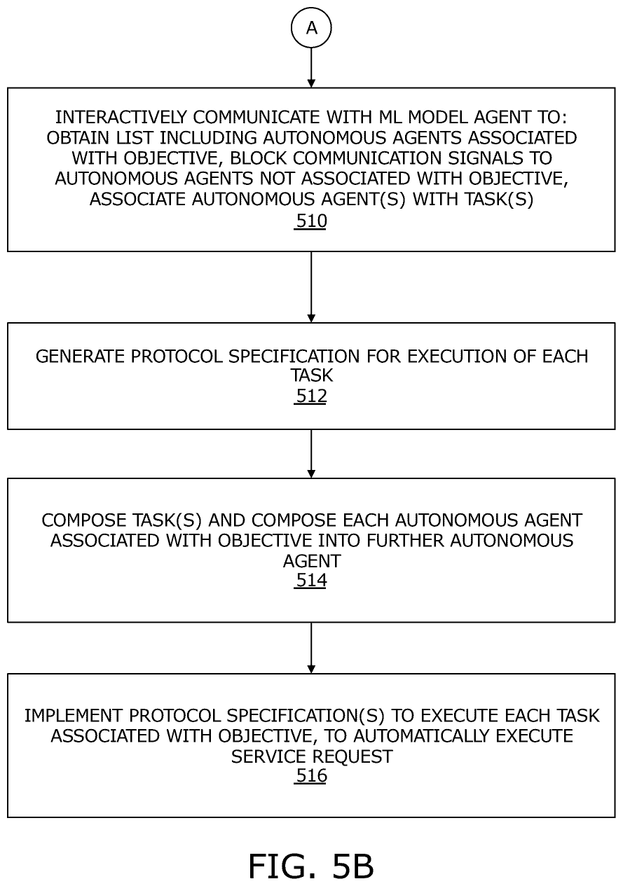

Referring to FIGS. 5A and 5B, illustrated is a flowchart illustrating steps of a method for enabling application of AAs across a plurality of problem domains, in accordance with an embodiment of the present disclosure. At 502, there is received, at a client-agent device (client-AA) comprising a software application, a service request and there is generated an objective associated with the service request, wherein the objective is in a form of one or more vectors recorded in a vector database. At 504, the objective is sent from the client-agent device (client-AA) to an agent-device (AA or micro-AA), wherein a software framework comprises the client-agent device (client-AA) and the agent-device (AA or micro-AA), and wherein the software framework is implemented using a decentralized computing network, and wherein the software framework comprises a plurality of modular and extensible software modules configured to operate as a plurality of AAs comprised within a plurality of computing devices, wherein the plurality of AAs are communicably coupled with each other. At 506, one or more queries are sent from a context-builder software module of the agent-device (AA or micro-AA) to a machine learning model agent (ML-Model AA) and/or the vector database is accessed to retrieve one or more tasks associated with previous queries in order to obtain a plurality of tasks associated with the objective. At 508, there is further implemented, by the context-builder software module, a step of interactively communicating with the machine learning model agent (ML-Model AA) for obtaining an order in which each task is to be executed. At 510, there is further implemented, by the context-builder software module, a step of interactively communicating with the machine learning model agent (ML-Model AA) for: obtaining a list including a plurality of autonomous agents (AAs or micro-AAs) that are associated with the objective, blocking communication signals between the client-agent device (client-AA) and autonomous agents which are not associated with the objective, associating at least one autonomous agent from the plurality of autonomous agents associated with the objective with at least one task and such that each task is associated with at least one autonomous agent associated with the objective. At 512, at least one protocol specification is generated for the execution of each task by the at least one autonomous agent associated with the task, upon receiving an invocation from the context-builder software module, using a protocol generator software module of the agent-device (AA or micro-AA), the protocol generator software module comprising a domain-independent protocol specification language, wherein the protocol specification is generated using the domain-independent protocol specification language. At 514, the at least one task is composed, using a build executor software module of the agent-device (AA or micro-AA), in an order defined for each task to be executed, and each autonomous agent associated with the objective is composed into a further autonomous agent (further-AA), and access to the further autonomous agent is encrypted to prevent tampering. At 516, the further autonomous agent (further-AA) implements the at least one protocol specification for executing each task associated with the objective and thereby automatically executes the service request.

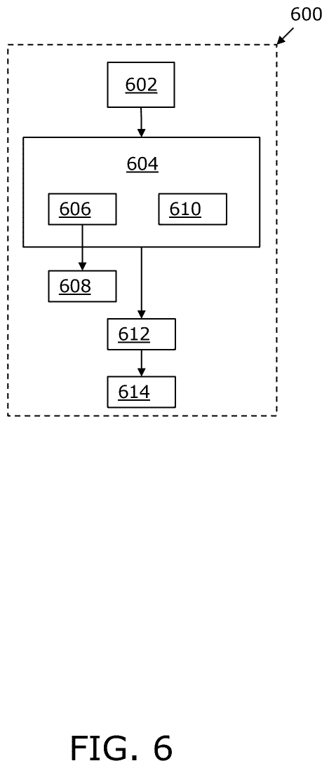

Referring to FIG. 6, illustrated is a block diagram of a system 600 for executing autonomous agents across a plurality of problem domains, in accordance with an embodiment of the present disclosure. As shown, the system 600 comprises a client agent 602 and an orchestration agent 604 communicably coupled to each other. The client agent 602 is configured to receive a service request; generate an objective corresponding to the service request by employing at least one data processing algorithm to match metadata associated with previous service requests with at least one service requested in the current service request, extract content from the match, and transform the extracted content into one or more representations stored in a data store, wherein the objective is in the form of the one or more representations stored in the data store; and transmit the objective to the orchestration agent 604 communicably coupled to the client agent 602. The orchestration agent 604 comprises an orchestration module 606 configured to execute one or more algorithms of an artificial intelligence (AI) model 608 using the objective as an input parameter; retrieve one or more tasks associated with previous queries to obtain a plurality of tasks associated with the objective; interactively execute the AI model 608 to obtain a list of a plurality of autonomous agents that are capable of performing the plurality of tasks and are associated with the objective; and assign, at least one autonomous agent from the plurality of autonomous agents with at least one task such that each task is assigned to at least one autonomous agent. The orchestration agent 604 is communicably coupled to an invocation generator module 610 that is configured to generate at least one task specification for execution of each task by the at least one autonomous agent associated with the task, using a structured invocation format, upon receiving a signal from the orchestration module 606. The system 600 also comprises a composition module 612 that is configured to compose each autonomous agent corresponding to the objective into a composite agent 614 by combining capabilities and functionalities of each autonomous agent corresponding to the objective. The composite agent 614 is configured to execute, using at least one processor, executable instructions defined in the at least one task specification to sequentially perform each task assigned to the composite agent 614, and to generate a service execution result corresponding to fulfilment of the service request.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for executing autonomous agents across a plurality of problem domains, the system comprising:
a client agent configured to:
receive a service request;
generate an objective corresponding to the service request by executing at least one data processing algorithm to match metadata associated with previous service requests with at least one service requested in the current service request, extract content from the match, and transform the extracted content into one or more structured data representations stored in a database, wherein the objective is in the form of the one or more structured data representations stored in the database; and
transmit the objective to an orchestration agent communicably coupled to the client agent;
the orchestration agent comprising:
an orchestration module configured to:
execute one or more algorithms of an artificial intelligence (AI) model using the objective as an input parameter;
retrieve one or more tasks associated with previous queries to obtain a plurality of tasks associated with the objective;
execute the one or more algorithms of the AI model to obtain a list of a plurality of autonomous agents that are capable of performing the plurality of tasks and are associated with the objective; and
assign at least one autonomous agent from the plurality of autonomous agents to at least one task such that each task is assigned to at least one autonomous agent;
an invocation generator module configured to, upon receiving a signal from the orchestration module, generate at least one task specification for execution of each task by the at least one autonomous agent associated with the task, using a structured invocation format; and
a composition module configured to compose each autonomous agent corresponding to the objective into a composite agent by generating a configuration data structure comprising execution logic defining associations between the plurality of autonomous agents and the plurality of task specifications assigned to the objective, thereby establishing a unified execution context for the composite agent,
wherein the composite agent is configured to execute the at least one task specification in accordance with the execution logic defined in the configuration data structure.

2. The system of claim 1, wherein the structured data representations comprise machine-readable data records including at least one of: encoded feature vectors, embedding vectors, or structured metadata objects.

3. The system of claim 1, wherein the configuration data structure comprises a plurality of machine-readable mapping entries, each mapping entry defining a linkage between a task specification and a corresponding autonomous agent.

4. The system of claim 1, wherein the execution logic defined in the configuration data structure comprises routing rules executable by the composite agent to determine which autonomous agent performs each task specification.

5. The system of claim 1, wherein the structured invocation format comprises structured parameter fields including at least one of: an operation identifier, input parameters, execution constraints, or expected output definitions.

6. The system of claim 1, wherein the orchestration module is further configured to obtain the plurality of autonomous agents using a registry component comprising a database of autonomous agents and associated metadata including at least one of: capability data, pricing parameters, or availability status, and to select at least one autonomous agent for association with a task based on the metadata.

7. The system of claim 1, wherein the composition module is further configured to generate a task completion record stored in the database, the task completion record comprising an identifier of a completed task and an identifier of an autonomous agent associated with the completed task, and to generate an audit log recording actions taken by the composite agent during execution of the task.

8. The system of claim 1, wherein the orchestration module is further configured to determine an order in which the plurality of tasks are to be executed using the AI model, validate the determined order prior to execution, and append validated tasks to an execution chain defining the order of execution.

9. The system of claim 1, wherein the composition module is further configured to apply access controls to the composite agent such that only autonomous agents associated with the objective are authorized to interact with the composite agent and to restrict access of the composite agent to only resources authorized for execution of the tasks associated with the objective.

10. The system of claim 9, wherein the access controls applied to the composite agent are enforced using cryptographic mechanisms including issuance of cryptographic keys to authorized autonomous agents, and wherein the task completion record or audit log is stored as an immutable record cryptographically linked to the composite agent.

11. A method for executing autonomous agents across a plurality of problem domains, the method comprising:
receiving a service request at a client agent;
generating an objective corresponding to the service request by executing at least one data processing algorithm to match metadata associated with previous service requests with at least one service requested in the current service request, extracting content from the match, and transforming the extracted content into one or more structured data representations stored in a database, wherein the objective is in the form of the one or more structured data representations stored in the database;
transmitting the objective to an orchestration agent communicably coupled to the client agent;
executing, by the orchestration agent, one or more algorithms of an artificial intelligence (AI) model using the objective as an input parameter;
retrieving one or more tasks associated with previous queries to obtain a plurality of tasks associated with the objective;
obtaining a list of a plurality of autonomous agents capable of performing the plurality of tasks;
assigning at least one autonomous agent to at least one task;
generating at least one task specification for execution of each task by the at least one autonomous agent using a structured invocation format;
generating a configuration data structure comprising execution logic defining associations between the plurality of autonomous agents and the plurality of task specifications assigned to the objective, thereby establishing a unified execution context; and
executing the at least one task specification in accordance with the execution logic defined in the configuration data structure.

12. The method of claim 11, wherein the structured data representations comprise machine-readable data records including at least one of: encoded feature vectors, embedding vectors, or structured metadata objects.

13. The method of claim 11, wherein the configuration data structure comprises a plurality of machine-readable mapping entries, each mapping entry defining a linkage between a task specification and a corresponding autonomous agent.

14. The method of claim 11, wherein the execution logic defined in the configuration data structure comprises routing rules executable to determine which autonomous agent performs each task specification.

15. The method of claim 11, wherein the structured invocation format comprises structured parameter fields including at least one of: an operation identifier, input parameters, execution constraints, or expected output definitions.

16. The method of claim 11, further comprising obtaining the plurality of autonomous agents using a registry component comprising a database of autonomous agents and associated metadata including at least one of: capability data, pricing parameters, or availability status, and selecting at least one autonomous agent for association with a task based on the metadata.

17. The method of claim 11, further comprising generating a task completion record stored in the database, the task completion record comprising an identifier of a completed task and an identifier of an autonomous agent associated with the completed task, and generating an audit log recording actions taken during execution of the task.

18. The method of claim 11, further comprising determining an order in which the plurality of tasks are to be executed using the AI model, validating the determined order prior to execution, and appending validated tasks to an execution chain defining the order of execution.

19. The method of claim 11, further comprising applying access controls such that only autonomous agents associated with the objective are authorized to interact during execution of the tasks and restricting access to only resources authorized for execution of the tasks associated with the objective.

20. The method of claim 19, wherein the access controls are enforced using cryptographic mechanisms including issuance of cryptographic keys to authorized autonomous agents, and wherein the task completion record or audit log is stored as an immutable record cryptographically linked to the configuration data structure.
